(19) United States
(12) Patent Application Publication
(10) Pub. No.: US 2015/0269175 A1
(43) Pub. Date: Sep. 24, 2015

(54) Query Interpretation and Suggestion Generation under Various Constraints

(71) Applicant: Microsoft Corporation, Redmond, WA (US)

(72) Inventors: Jeremy K. Espenshade, Seattle, WA (US); Bo-June Hsu, Woodinville, WA (US); Kuansan Wang, Bellevue, WA (US)

(73) Assignee: Microsoft Corporation, Redmond, WA (US)

(21) Appl. No.: 14/221,526

(22) Filed: Mar. 21, 2014

(51) Int. Cl. G06F 17/30; G06N 5/02; G06F 17/27

(52) U.S. Cl. CPC G06F 17/3097; G06F 17/3053; G06F 17/3043; G06F 17/271; G06N 5/02

(57) ABSTRACT

A query processing system (QPS) is described herein for interpreting a user's input query against a structured knowledge base, to provide an output result. The output result may include one or more query suggestions, each providing a recommendation as to how a user may refine his or her query. In addition, or alternatively, the output result may specify one or more entity items which satisfy the user's query. In interpreting the user's query, the QPS may rely on a collection of rule modules which identify and process different types of constraints that may be expressed in the input query, including numeric constraint, nested constraints, comparison-based constraints, and so on.

### BACKGROUND

Search systems commonly employ autosuggestion mechanisms. According to a typical user experience, a user triggers the autosuggestion mechanism by typing part of a query into an input region of a search system interface. The autosuggestion mechanism then identifies zero, one, or more query suggestions, and presents these suggestions to the user, typically immediately beneath the input region. Each query suggestion acts as a refinement of the user's partial query. For example, if the user inputs the name of a musician, the autosuggestion mechanism may suggest the name of that musician's latest work, appended to the end of the user's partial query. In a common strategy, the autosuggestion mechanism may produce such a suggestion based on popularity information and/or dictionary resources. For example, if a large number of users typically searched the musician's name together with his latest work, then the autosuggestion mechanism may identify this query as a viable suggestion for the user's consideration.

The above type of autosuggestion mechanism has potential drawbacks. For example, the above type of autosuggestion mechanism simply reflects common behavior of prior users, and thus there is no guarantee that the suggestion will capture the true semantic intent of the current user, especially where that semantic intent expresses complex or nuanced constraints. Further, there is no guarantee that the suggestion will yield meaningful information (when the user executes a search based on the suggestion). For example, while many people may have entered a particular query, that fact, in itself, does not imply that the prior searches were successful.

### SUMMARY

A query processing system (QPS) is described herein for interpreting a user's input query against a structured knowledge base, to provide an output result. In one illustrative implementation, the QPS operates by first receiving an input query, corresponding to a complete query or a yet-to-be-completed query. The QPS then interprets the input query with respect to information provided in the structured knowledge base, using a set of rule modules associated with a grammar. This interpretation yields a set of one or more constraints expressed by the input query. The QPS then provides an output result based on the set of constraints. The output result may include one or more query suggestions, each providing a recommendation as to how a user may refine his or her query. In addition, or alternatively, the output result may identify one or more entity items which satisfy the user's query.

The rule modules are capable of processing many different types of constraints that may appear in the input query, including complex and nuanced constraints. For example, at least one rule module in the grammar may be used to interpret a numeric constraint that is expressed in the query. The numeric constraint may specify any of a lower-bound threshold value, an upper-bound threshold value, a range of values, a specific value (such as date), etc.

Further, rule modules can reference other rule modules. For example, such a rule model may successfully parse the query, “Buildings that are taller than the Golden Gate Bridge” by using a nested rule module to determine the height of the Golden Gate Bridge, and then using that height value as a lower-bound constraint in the parent rule module.

According to another illustrative aspect, the QPS can decompose a master constraint, specified in the input query, into two or more component sub-constraints. The QPS can then interpret the input query based on the sub-constraints.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a query processing system (QPS) for processing a user's input query.

FIG. 2 shows a portion of one table of a structured knowledge base, for use in conjunction with the QPS of FIG. 1.

FIG. 3 shows a simplified example of one manner of operation of the QPS of FIG. 1.

FIG. 4 shows one type of user interface presentation that the QPS of FIG. 1 may use to interact with the user, e.g., by receiving an input query from the user, and for providing an output result, generated by the QPS.

FIG. 5 shows computing functionality for implementing the QPS of FIG. 1, according to a first implementation.

FIG. 6 shows computing functionality for implementing the QPS of FIG. 1, according to a second implementation.

FIG. 7 is a process which describes one manner of operation of the QPS of FIG. 1.

FIG. 8 shows one implementation of a query interpretation module, which is a component of the QPS of FIG. 1.

FIG. 9 shows a plurality of rule modules that collectively define a grammar. The query interpretation module (of FIG. 8) performs its tasks using the rule modules.

FIG. 10 show an implementation of a parent rule module that contains an embedded reference to at least one other rule module.

FIG. 11 shows an example of the type of parent rule module shown in FIG. 10.

FIGS. 12 and 13 respectively show two other rule modules.

FIG. 14 shows functionality for decomposing a main constraint, specified in the input query, into two or more sub-constraints, and then processing the input query with reference to the plural sub-constraints.

FIG. 15 shows an application of the type of processing set forth in FIG. 14, where, here, the sub-constraints correspond to sub-regions within a map region. FIG. 15 also demonstrates the application of a weighting function to the sub-regions.

FIG. 16 shows functionality for identifying an original prefix in the input query, for using the original prefix to produce two or more extended prefixes, and for processing the input query with reference to the plural extended prefixes.

FIG. 17 is a procedure which describes one manner of operation of the query interpretation module of FIG. 8.

FIG. 18 is a process which describes one manner of operation of a numeric-constraint rule module, which is configured to process numeric constraints in the input query.

FIG. 19 is a process which describes one manner of operation of the range processing functionality of FIGS. 8 and 14.

FIG. 20 is a process which describes one manner of identifying at least one variant of a word in the input query, and for interpreting the input query based on the variant(s).

FIG. 21 is a process which describes one manner of operation of the prefix processing functionality of FIGS. 8 and 16.

FIG. 22 shows an intersection module for intersecting sets of entity lists, generated by the query interpretation module of FIG. 8. The intersection module is a component of the QPS of FIG. 1.

FIG. 23 is a process which describes one manner of operation of the intersection module of FIG. 22.

FIG. 24 shows a post-processing module for generating an output result based on matching items identified by the intersection module. The post-processing module is another component of the QPS of FIG. 1.

FIG. 25 is a process which describes one manner of operation of the post-processing module of FIG. 24.

FIG. 26 shows illustrative computing functionality that can be used to implement any aspect of the features shown in the foregoing drawings.

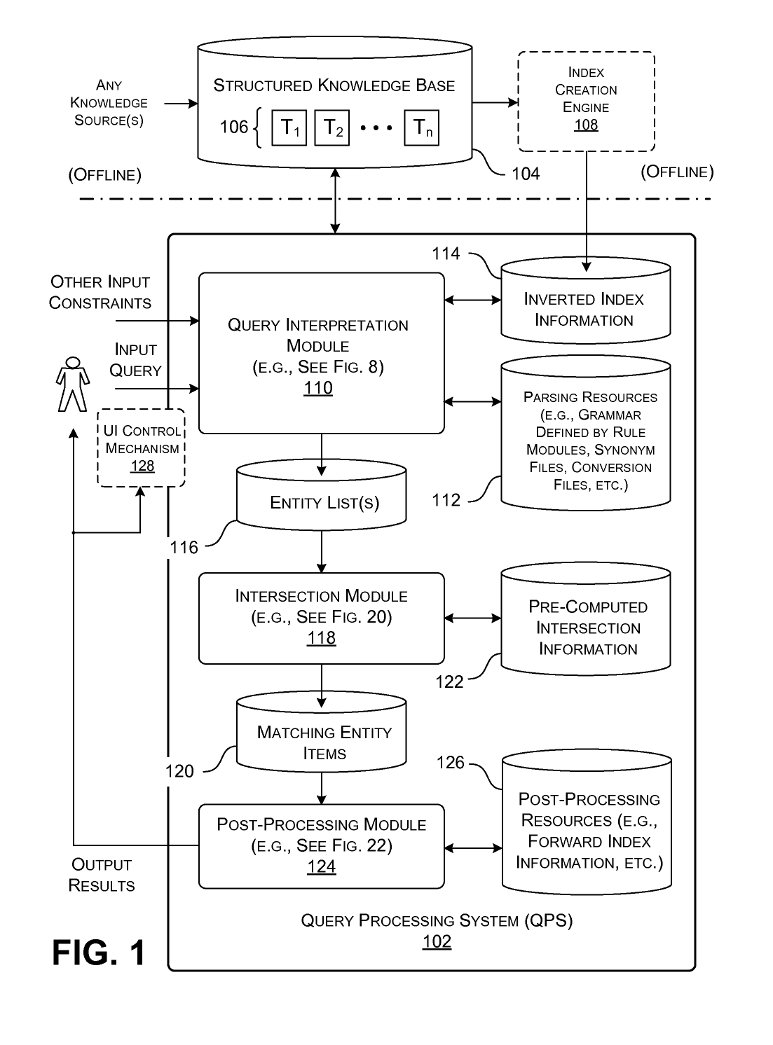

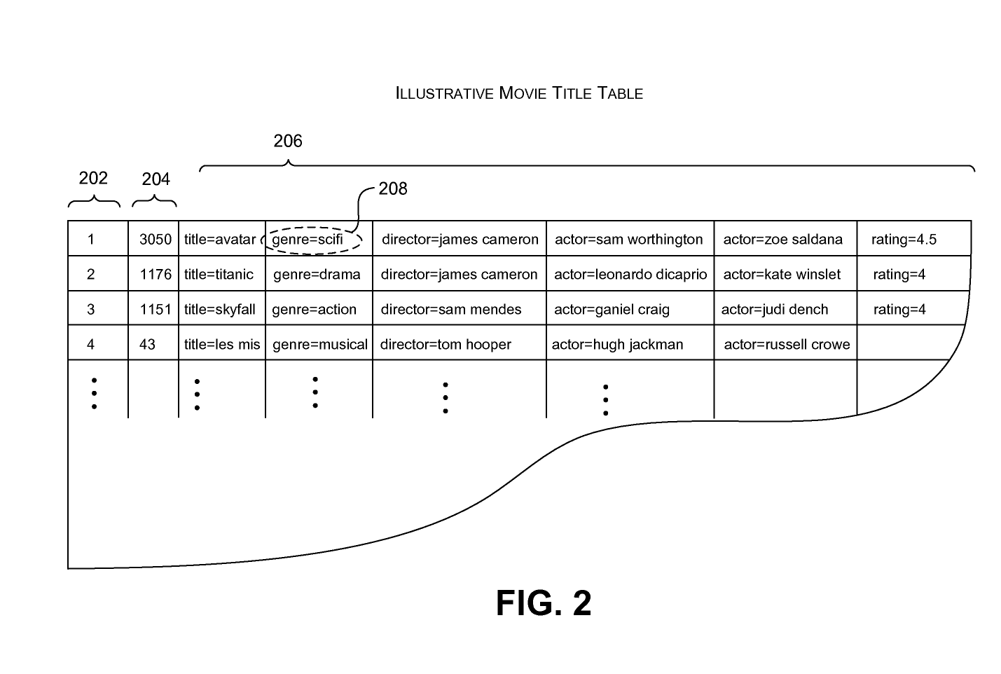

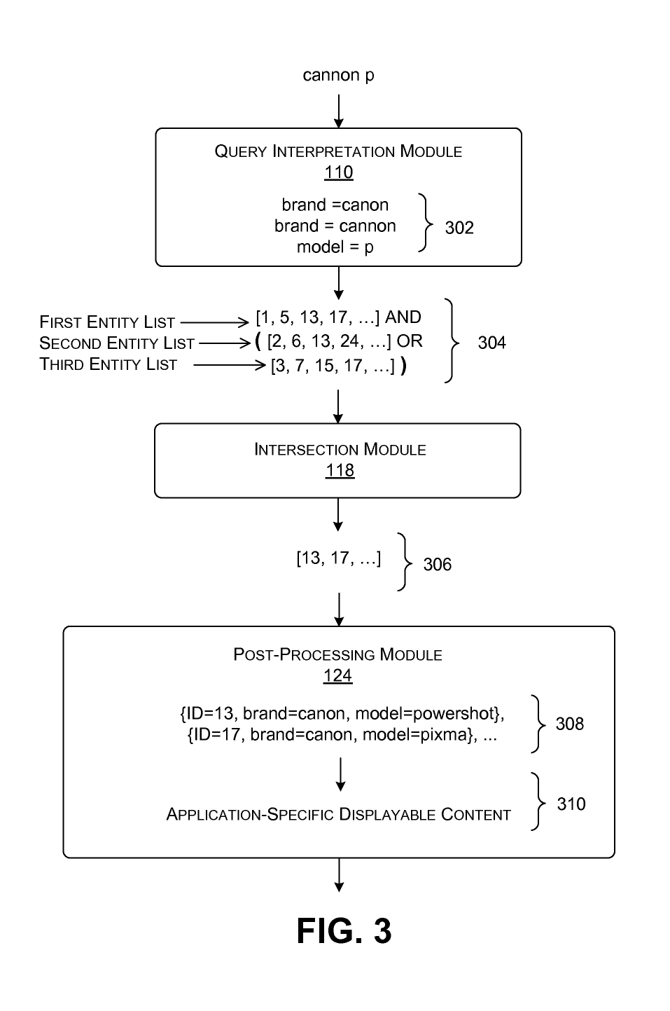

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A provides an overview of a query processing system (QPS). Sections B, C, and D respectively describe a query interpretation module, an intersection module, and a post-processing module, which represent components of the QPS described in Section A. Section E describes illustrative computing functionality that can be used to implement any aspect of the features described in the previous sections.

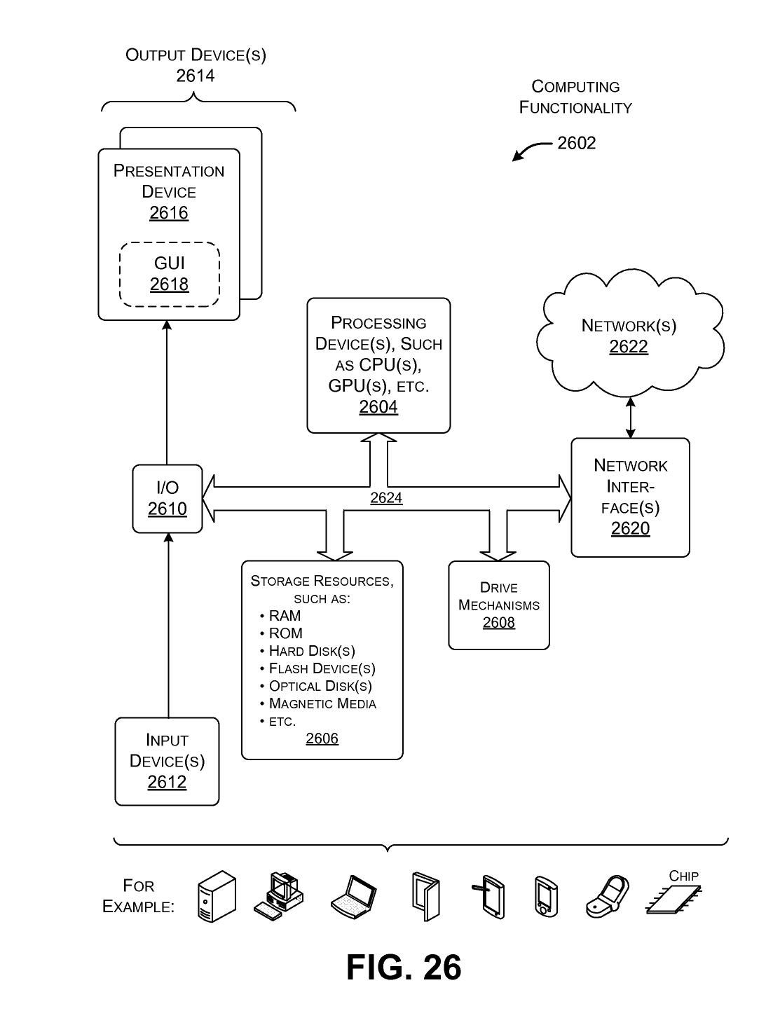

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 26, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Further, any description of a single entity is not intended to preclude the use of plural such entities; similarity, a description of plural entities is not intended to preclude the use of a single entity. Finally, the terms “exemplary” or “illustrative” refer to one implementation among potentially many implementations.

A. Overview of the Query Processing System (QPS)

FIG. 1 shows a query processing system (QPS) 102 for processing a user's query with reference to a structured knowledge base stored in one or more data stores 104. For example, the QPS 102 may accept an input query from a user, corresponding to a complete query or a yet-to-be-completed query. In response, the QPS 102 can provide zero, one, or more query suggestions to the user. Each query suggestion provides a recommendation as to how the user may complete his or her query. For example, if the user types the partial query, “Suzuki off-road,” the QPS 102 may provide a suggestion that includes the original query, together with the terms “AWD” (for all-wheel drive), or “SX4” (which is a model having AWD produced by the car manufacturer Suzuki Motor Corporation). In addition, the QPS 102 may provide information items regarding entities described in the structured knowledge base which match the partial query. For example, the QPS may provide information items regarding the Suzuki SX4, together with information regarding one or more motorcycles offered by this company.

The users may engage the suggestions and information items in various ways. In one scenario, for instance, a suggestion or information item may directly answer the user's query, without further inquiry necessary by the user. In another case, a suggestion or information item may provide guidance to the user in further refining his or her query. In connection therewith, assume that a user's original query is ambiguous. The QPS 102 can provide suggestions and/or information items that pertain to different interpretations of the query. By choosing one of the suggestions or information items, the user may refine his or her query along a particular interpretative path.

As to terminology, an “entity” may correspond to any identifiable focus of interest. In the most prominent examples in this description, different entities correspond to products produced by companies. But an entity may also correspond to any organization (e.g., a company), a person, a group of people, an animal, a place, a region, a building, a naturally occurring article, and so on. Each entity has one or more characteristics referred to as attributes. For example, the car model SX4 may be characterized by specifying its model number, engine size, horse power rating, fuel rating, color, and so on, all of which constitute attributes of that model. An attribute may be assigned an attribute value. For example, with respect to the SX4 model, “automatic” constitutes a value for the attribute “transmission.” The term “entity item” refers to any entry in a data store which describes an entity. The term “attribute value item” refers to an entry in a data store which describes an attribute value.

Overall, the structured knowledge base provides information regarding a plurality of entities in a structured form, e.g., using a particular data structure. For example, in the example of FIG. 2, the structured knowledge base includes a series of rows corresponding to different respective movies. In other words, each row constitutes an entity item, which represents a particular movie. In this illustrative case, the first column 202 may provide indices associated with the different entity items. A second column 204 may provide entity scores associated with the entity items. For example, each entity score may reflect the popularity of an associated movie title. Popularity can be assessed in any manner, e.g., based on any of: the sales activity associated with the movie; the number of times that users have viewed the movie; the number of times that users have searched for the movie title using a commercial search system, and so on. In one implementation, the table can arrange the entity items in order of entity scores, with the most popular entity item appearing first (or last). A series of remaining columns 206 are devoted to different attributes of the movies. Each entry in this section corresponds to an attribute-value pair, including an attribute item and an associated attribute value item. For example, the entry 208 indicates that the genre of the movie having the title “Avatar” is “science fiction.” The information shown in FIG. 2 is presented by way of example, not limitation; other structured knowledge bases may provide different content, and/or can use other data structures to organize the content.

Returning to FIG. 1, the structured knowledge base may include one or more tables 106, devoted to different respective topics. For example, the structured knowledge base can devote a first table to movies (as shown in FIG. 2), a second table devoted to musical works, a second title devoted to books, and so on.

Any offline process can be used to create the structured knowledge base. For example, in one case, and administrator can create the structured knowledge base from “scratch,” that is, by storing attribute value items in particular locations within the structured knowledge base as they are received or created. In another process, an administrator can extract information items from another repository of information (which may be unstructured or structured), and store those information items in the structured form specified by the knowledge base. For example, in one case, the structured knowledge base may be created by importing the entity items defined by a digital personal assistance service, or the like. That digital personal assistance service, for example, may organize the entity items in a graph data structure.

An administrator may also use an index creation engine 108 to produce inverted index information for the structured knowledge base. The inverted index information specifies, as lookup keys, the attribute value items that appear in the structured knowledge base. For each such attribute value item, the inverted index information identifies the entity items that include the particular attribute value item as an entry. For example, for the attribute value item “science fiction” in FIG. 2, the inverted index information may identify the movie titles which have been assigned this particular genre. “Avatar” is one entity item in that list.

More specifically, in one illustrative implementation, the index creation engine 108 can store inverted index information for each column of each table. The index creation engine 108 can also provide a master data structure that can be used to identify the particular tables which store a particular attribute value item. For example, the master data structure can indicate that the attribute value item “off-road” appears in a table devoted to cars, a table devoted to motorcycles, and a table devoted to camping equipment. As will be described in greater detail below, an offline process may also decompose certain information items into plural component items, and represent each of the component items as a distinct entry in the inverted index information; this process, for instance, can be used to represent sub-ranges within a master range, prefix extensions associated with a specified prefix, and so on, etc.

In practice, the index creation engine 108 may update the inverted index information on any basis, such as a periodic basis (e.g., every 24 hours, or every week, etc.), and/or on an event-driven basis (e.g., upon any changes being made to the structured knowledge base, such as the introduction of new items, the removal of items, etc.).

In a real time phase of operation, the QPS 102 processes an input query in plural stages using different respective modules. This section provides an overview of the different modules of the QPS 102. Later sections provide additional details pertaining to the respective modules. Further note that any module of the QPS 102 can be used in other contexts, that is, other than particular system shown in FIG. 1.

To begin with, a query interpretation module 110 analyzes the input query to determine one or more constraints expressed by the query. A constraint constitutes any condition that potentially limits the entries in the structured knowledge base which satisfy the query. For example, a query that simply specifies “automatic transmission” operates as a constraint because it restricts the set of matching items to those that contain the attribute-value pair “transmission=automatic.” If the user adds the phrase “under $300” to the query, he or she has added another constraint, insofar as that phrase further limits the set of matching items to those having price values under 300 dollars.

The QPS 102 identifies constraints in the input query using the inverted index information provided in one or more data stores 114, and using parsing resources provided in one or more data stores 112. The inverted index information was described above. It provides a mechanism for identifying entity items and attribute value items in the structured knowledge base which match specified input terms. For example, in the simple example set forth above, the inverted index information can identify the entity items in the database which contain the attribute-value pair “transmission=automatic.” In one (non-limiting) data structure, each such entity item may correspond to a row of the structured knowledge base.

The parsing resources may include a collection of rule modules which collectively define a grammar for use in interpreting the input query. The grammar corresponds to a complete set of valid (grammatical) queries that can be made, conformant with the rules defined by the rule modules. That set of valid queries may further be conceptualized as a space. For instance, the space may be represented as a hierarchical tree of nodes and branches, a lattice, or other data structure. A particular path through the space defines one particular interpretation that is valid, meaning that it conforms to the rules established by the set of rule modules.

The parsing resources may include other supplemental information, such as one or more synonym files, one or more conversion files, and so on. A synonym file describes synonyms for terms that may appear in the structured knowledge base. For example, synonyms for the attribute value “manual” (in the context of describing a manual transmission) may be “stick shift,” “standard,” etc. In addition, synonyms may also include spelling variations of an input term, including common misspellings, variations that include or exclude special characters, such as umlauts, etc. Synonyms may also encompass terms and phrases that are assessed as being similar from a higher-level semantic standpoint, as when “electric cars” is linked to “fuel efficient vehicles.”

The conversion files can be used to identify other variations of input queries. For example, in one case, one or more conversion files may be used to support generic spelling correction (e.g., “ei” to “ie”), rather than whole phrase corrections supported via synonym replacement (e.g., “receive” to “receive”). More specifically, the QPS 102 can leverage the conversion files to apply multiple conversions to a single phrase. The QPS 102 can also use conversion files to perform accent and casing normalization.

Another type of conversion and/or synonym file may provide variants of terms in the structured knowledge base with respect to regions that speak different natural languages or regions that speak different variations of the same natural language. For example, the conversion file may indicate that the British word “devise” is a spelling variant of the American word “device,” and so on.

Another type of conversion and/or synonym file can provide different interpretations of a phonetic expression of a word that is natively expressed using non-Latin characters, such as Chinese characters, etc. For example, a user may attempt to express a Chinese word using Latin characters, e.g., by spelling out how the word sounds according to the conventions of Pinyin. But the interpretation of that phonetic-based expression may be ambiguous in some circumstances because several Chinese words may have similar sounds when spoken. The conversion and/or synonym file maps the phonetic expression (e.g., the Pinyin expression) to all of the Chinese words that it can potentially represent.

In operation, the query interpretation module 110 interprets the input query by selecting one or more paths through a space, defined by the grammar Each path defines a possible interpretation of the query. The query interpretation module 110 may use any technique to perform its search through the space, such as an exhaustive examination of all possible interpretation options, a best-first search strategy (such as the A* search algorithm), and so on. Section B provides additional detail regarding analysis performed by the query interpretation module 110.

As a result of its analysis, the query interpretation module 110 generates one or more entity lists, and stores the entity lists in one or more data stores 116. Each entity list corresponds to a list of one or more entity items that satisfy at least one constraint. For example, assume that the input query reads, “hatchbacks and bucket seats.” A first constraint in this query specifies a set of cars that are characterized as hatchbacks. The entity list for that constraint identifies the set of vehicle-related entity items in the knowledge base that possess the attribute-value pair “back access=hatchback,” or the like. A second constraint specifies vehicles having bucket seats. The entity list for that constraint identifies a set of vehicle-related entity items in the knowledge base that possess the attribute-value pair “seat style=bucket,” or the like.

Alternatively assume that the user inputs the query, “off-road 5-speed.” By inputting “off-road,” the user may be referring to either automobiles having all wheel drive, or to off-road-style motorcycles, or to some other topic. The query interpretation module 110 can therefore generate different entity lists for these alternative interpretations. In this case, at least some of the entity lists may originate from different respective tables.

In a similar manner, the query interpretation module 110 can generate separate entity lists for different spelling corrections of a term, different synonym matches of a term, different region-specific expressions of a term, different interpretations of a phonetically-expressed term, and so on. In each such example, the query interpretation 100 can form a disjunctive combination of the entity lists.

In addition, the query interpretation module 110 can decompose a master constraint into plural sub-constraints, generate entity lists for the respective sub-constraints, and then form a disjunctive combination of those lists. In addition, or alternatively, the query interpretation module 110 can extend an originally-specified prefix in different ways, generate entity lists for the respective different extensions, and then form a disjunctive combination of those lists. The explanation will provide detailed examples of these features at a later juncture.

In addition, the query interpretation module 110 can find those paths through the grammar space which represent the most likely extensions of the user's query (instead of just attempting to interpret the words that the user has provided). For example, assume that the user inputs the query, “Bruce Willis Action movies in.” The query interpretation module 110 may find at least one path through the grammar space that corresponds to the pattern, “Bruce Willis Action movies in 2013,” based on a determination that this expanded phrase is a likely completion of the user's query. Another likely extension may correspond to “Bruce Willis Action movies in 3D,” and so on. The query interpretation module 110 can then generate one or more entity lists for each such extended interpretation. These entity lists are predicated, at least in part, on constraints that are not yet explicitly expressed by the user's query, but may be said to be implicitly expressed by the query.

As can therefore be appreciated, in some scenarios, the query interpretation module 110 can potentially generate a large number of entity lists. Further, many of the entity lists may have a large number of entries. The query interpretation module 110 can bind these entity lists together in different logical ways, depending on the semantic connotations of the entity lists. For example, consider the query “off-road 5-speed.” In a first master interpretation, “off-road” represents a characteristic of automobiles. The query interpretation module 110 may create a first disjunctive set of entity lists which pertain to the constraint “off-road,” in the context of automobiles, and a second disjunctive set of entity lists which describe “five-speed,” again in the context of automobiles. The entity lists in the first set, for example, may correspond to different spellings and synonyms of “off-road,” while the entity lists in the second set may correspond to different spellings and synonyms of “5-speed.” The QPS 102 can then form a conjunction between the first set of entity lists and the second set of entity lists, in the manner described below. In a second master interpretation, “off-road” represents a characteristic of motorcycles. In a similar manner to that described above, the query interpretation module 110 can create a first disjunctive set of entity lists which describe “off-road” (now in the context of motorcycles) and a second disjunctive set of entity lists which describe “5-speed” (now in the context of motorcycles). As a final outcome, the user will receive results which derive from the interpretation of “off-road” as a characteristic of cars, and the interpretation of “off-road” as a characteristic of motorcycles. Yet more complex ways of combining entity lists are possible.

To repeat, Section B will provide further details regarding the above technical features. But one feature that warrants introductory mention here is in regard to the manner in which the query interpretation module 110 interacts with the structured knowledge base when generating the entity lists. For example, assume that the query interpretation module 110 identifies a possible constraint in the input query, associated with a particular rule module. The query interpretation module 110 can invoke the rule module to investigate the structured knowledge base, via the inverted index information in the data store 114, to determine whether it contains one or more information items to which the constraint pertains.

For example, assume that the user inputs the term “Mount Rainier,” which refers to a mountain in the U.S state of Washington. Further assume that this term implicates a particular rule module. The query interpretation module 110 can use the rule module to determine whether the knowledge base actually includes an entry associated with the term “Mount Rainier,” or its appropriate synonyms. Assume there is no such entry, at least in a mountain-related table of the knowledge base. In response, the query interpretation module 110 may indicate that an interpretation that is predicated on the term “Mount Rainier” being a mountain is not viable. Further, the query interpretation module 110 will not explore any refinements which depend, at a founding premise, that “Mount Rainier” is a mountain. Nor will the query interpretation module 110 store an entity list corresponding to the premise that “Mount Rainier” is a mountain.

In other cases, the failure of the structured knowledge base to satisfy a particular constraint is relative to a particular context within an interpretative path. For example, assume that the user inputs the phrase “off-road automatic transmission.” As noted above, there is a possibility that “off-road” could be referring to automobiles or motorcycles. But the particular interpretative path which leads to the consideration of motorcycles having automatic transmissions may not be viable, as these types of vehicles in one particular knowledge base do not include automatic transmissions. As a result, the query interpretation module 110 can be configured to exclude the above-noted interpretation, and any other child-path interpretations which depend on that interpretation.

In other cases, the query interpretation module 110 may identify an interpretation as being semantically valid. But later stages of analysis, performed by the QPS 102, may ultimately determine that such an interpretation has no results in the structured knowledge base. For example, assume that the user inputs the query, “Friends of mine who work in London.” There is nothing logically inconsistent about this query, but the QPS 102 may discover, upon intersecting entity lists (or earlier in the analysis), that the user, in fact, has no friends who work in the city of London.

As a final consequence of the above-described behavior, the user will receive query suggestions and entity information which reflects content that is actually stored in the structured knowledge base, and which is actually consistent within itself. For example, the user will not receive any hits for a query which is looking for new Bugatti sports vehicles under $40,000, as this type of vehicle is famously expensive, and cannot be purchased for under $40,000. In other words, the output results generated by the QPS 102 reflect reality, that is, insofar as the information presented in the structured knowledge base reflects reality.

At the same time, note that QPS 102 can provide meaningful output results to the user even though no other user has posed the same query as the user. This is because the QPS 102 can leverage rule modules that define a large universe of possible queries, many of which have never been submitted before.

Continuing on with the description of FIG. 1, an intersection module 118 performs an intersection among the sets of entity lists stored in the data store(s) 116. In many cases the intersection may correspond to an intersection between unions. For example, consider the example above in which the user inputs “off-road 5-speed.” Assume that “off-road” is associated with two or more variations, along with two or more respective entity lists. Similarity, assume that “5-speed” is associated with two or more variations, along with two or more entity lists. The intersection operation corresponds to a conjunction between the first disjunctive combination of entity lists and the second disjunctive combination of entity lists. As stated above, in other cases, the intersection module 118 may combine the lists in a more complex and context-specific manner. For example, the QPS 102 can produce suggestions that stem from different interpretations of the input query, which, in turn may leverage different tables of the structured knowledge base; to perform that task, the QPS 102 can collect sets of entity lists associated with different interpretations, and perform separate intersections on those respective sets.

The entity items that are produced as a result of an intersection are referred to herein as matching items. One or more data stores 120 may store the matching items. Each matching item has a combined score that is computed in the manner specified in Section C. Generally, the score reflects the likelihood that the matching item represents the semantic intent of the user in entering the query.

The intersection module 118 can rely on pre-computed intersection information that is provided in one or more data stores 122. The pre-computed intersection information reflects the outcome of combining certain entity lists together. For example, for a certain intersection of lists, the pre-computed intersection information reflects the highest (i.e., most favorable) score produced by the intersection, associated with one of the matching items identified in the intersection. The intersection module 118 can use the pre-computed intersection information as a guide to determine whether it is worthwhile to compute the intersection of a group of entity lists. That is, if the intersection module 118 can determine, in advance, that the intersection will yield matching items having relatively low scores, then it may opt to omit performing that intersection. In one implementation, an administrator can, as an offline process, store intersection information for intersections which yield over a prescribed number K of matching items. For other intersections, the intersection module 118 can compute the intersections in real-time fashion to generate the matching items and their respective scores.

A post-processing module 124 presents an output result based on the matching items provided in the data store(s) 120, using one or more post-processing resources provided in one or more data stores 126. For example, the post-processing module 124 can use forward index information to retrieve additional information regarding each of the matching items in the data store(s) 120. For example, the post-processing module 124 can retrieve the attribute value items associated with each matching item, along with accepted synonyms of those attribute value items. The post-processing module 124 can generate an output result on the basis of the above-described information, together with information regarding the original query which the user has entered. Section D provides further information regarding the operation of the post-processing module.

As noted above, the output result may include zero, one, or more suggestions to the user, informing the user as to how he or she may wish to refine the query. The output result may also include information regarding the matching items, expressed in any form. The QPS 102 can also modify the user interface that is presented to the user based on the output result, via a user interface (UI) control mechanism 128. The user may subsequently interact with the UI control mechanism 128 to further refine the input query.

FIG. 3 presents a simplified example of the operation of the QPS 102 of FIG. 1. Assume here that, at particular juncture, the user has inputted the query “cannon p,” with the intent of obtaining information about a camera produced by the camera manufacturer Canon, which begins with the letter “p”. In other words, the user has misspelled the name of the manufacturer as “Cannon,” when it should appear as “Canon,” and the user has not yet completed typing out the name of the model name.

The query interpretation module 110 explores at least three constraints 302 in the query. The first constraint specifies that the name of the brand is “cannon.” The second constraint specifies that the name of the brand is, alternatively, “canon.” And the third constraint indicates that the model name starts with the letter “p”. Although not expressly illustrated, the query interpretation module 110 may fan out the prefix “p” into a series of extended prefixes, such as “pa,” “pi,” “po,” “pu,” and “py,” each operating as a sub-constraint in its own right. Such a fan-out operation is appropriate when the inverted index information stores prefixes in a corresponding manner, e.g., corresponding to “pa,” “pi,” “po,” etc. In other cases, the inverted index information may provide a single entry for the prefix “p,” in which case no fan-out is performed. Later portions of this disclosure set forth additional details regarding the manner in which the QPS 102 may process prefixes.

The query interpretation module 110 generates a set of entity lists 304 that reflect the constraints. More specifically, the first entity list corresponds to the constraint “brand=canon.” The second entity list describes entity items that match the extended prefix “po”. The third entity list describes entry items that match the extended prefix “pi”. Assume that the constraint “brand=cannon” does not match any entity items in the knowledge base, and therefore there is no entity list corresponding to this interpretation (although, in another scenario, it is possible that there could be). Similarly, the other extended prefixes do not match any entity items in the knowledge base.

The intersection module 118 performs an intersection between the first entity list and the second entity list, and between the first entity list and the third entity list. This yields a set of matching items 306. For example, the common entry item No. 13 appears in both the first and second entity lists, and therefore qualifies as a matching item. The common entry item No. 17 appears in the first and third entity lists, and therefore qualifies as another matching item. Although not illustrated, the two matching items include respective combined scores which convey how closely they are purported to match the user's search intent.

The post-processing module 124 uses the forward index information to retrieve additional information 308 regarding matching item Nos. 13 and 17. The post-processing module 124 then generates any output result 310 which may take into account any information imparted by the information 308 and the original query, among other possible information items.

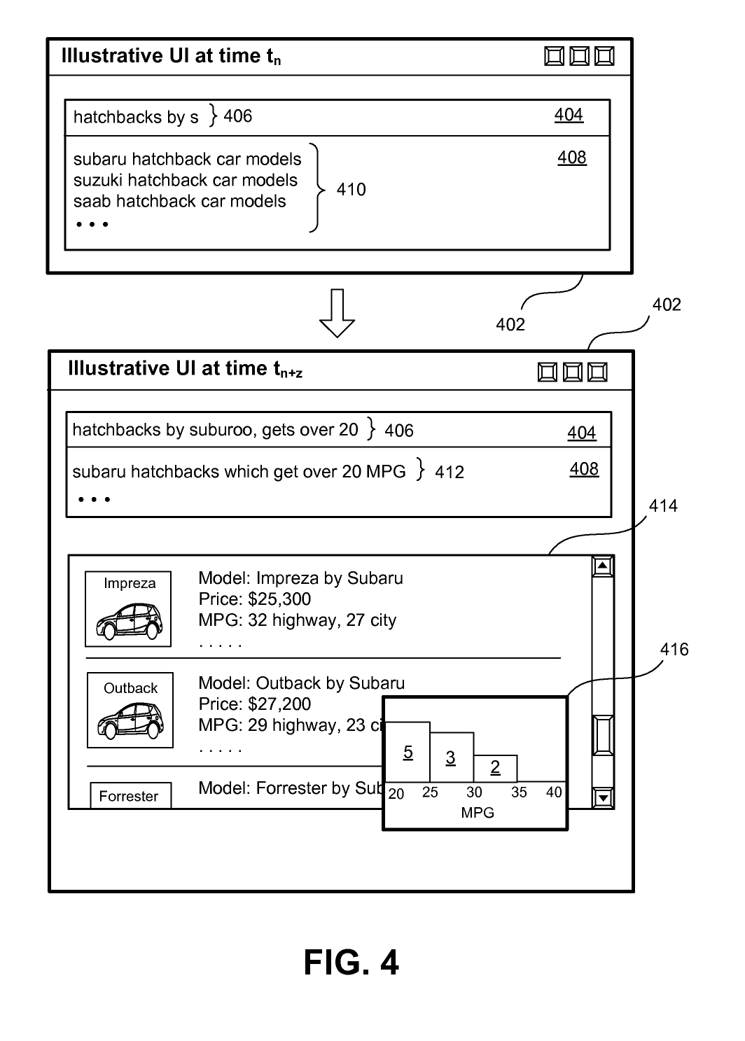

FIG. 4 shows one example of a user experience that may be delivered by the QPS 102 of FIG. 1. Other implementations of the QPS 102 can vary any aspect of the experience shown in FIG. 4, including the selection of user interface features, the appearance and arrangement of the user interface features, the behavior of the user interface features, and so on.

Assume that the QPS 102 delivers the user interface experience via at least one user interface presentation 402. That user interface presentation 402 includes a text entry region 404 in which the user enters a partial query 406 at a particular time tₙ, reading “hatchbacks by s.” The user interface presentation 402 includes a suggestion region 408 beneath the query entry region 404 which provides a number of suggestions 410 as to how the user may wish to complete his or her query. These suggestions 410 differ by identifying different car manufacturers that begin with the letter “s”. By virtue of the behavior described above with reference to FIG. 1, the suggestions 410 may omit any entity items that do not satisfy the constraint(s) specified in the query. For example, hypothetically assume that the car manufacturer Saturn has never produced a hatchback; the suggestions 410 would therefore exclude an entry for the manufacturer Saturn.

At a later instance of time (t_{=n+z}), assume that the user has added to the query 406, such that it now reads, “hatchbacks by suburoo, gets over 20,” where “suburoo” represents a misspelling. It is now a good possibility that the user is interested in finding vehicles produced by the manufacturer Subaru, which offer a fuel economy of greater than 20 miles per gallon. The suggestion region 408 is updated to reflect just such a suggestion 412, reading “subaru hatchback which get over 20 MPG.”

The suggestions provided in the suggestion region 408 constitute one type of output result produced by the QPS 102. In addition, or alternatively, the QPS 102 can provide information regarding the entity items which match the input query, referred to above as matching items. For example, in a display region 414, the QPS 102 can present a scrollable or non-scrollable list of result items that provide information about the matching items, or the top n matching items. In a display region 416, the QPS 102 can present the set of matching items in a histogram format, e.g., by grouping the matching items into different buckets for different respective MPG ranges. The histogram organizes items along an axis associated with fuel economy because the user's input query 406 expresses its numeric constraint with respect to a fuel-related dimension. The histogram could alternatively present items along an axis devoted to price if the user's input query 406 expressed an interest in cost. Other histograms can present information with respect to two or more dimensions.

In one case, the QPS 102 produces the regions (414, 416) based on information extracted from the knowledge base, without performing a formal search (e.g., without retrieving documents associated with the identified entities). In another case, the QPS 102 produces the regions (414, 416) in response to performing such a formal search.

The two modes of presentation described above (with respect to regions 414 and 416) are presented by way of example, not limitation. Other implementations of the QPS 102 can use other modes for presenting the set of matching items.

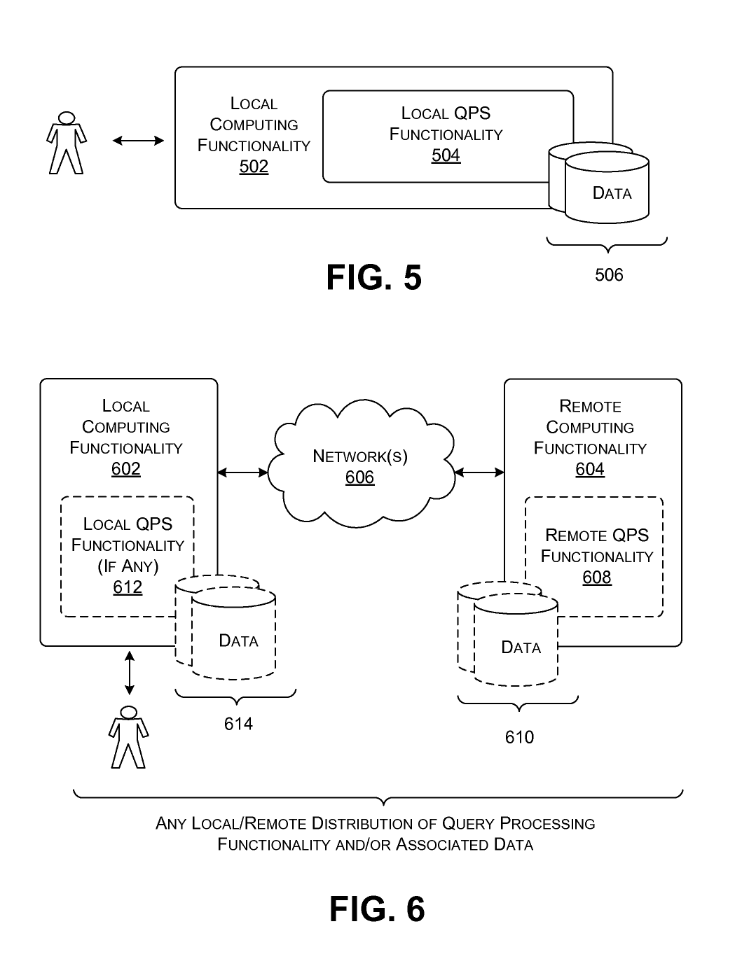

FIG. 5 shows a local stand-alone implementation of the QPS 102 of FIG. 1. In this case, local computing functionality 502 provides local QPS functionality 504 which, together with one or more local data stores 506, implements all aspects of the QPS 102 of FIG. 1. The local computing functionality 502 may correspond to any computing device, such as a workstation computing device, a set-top box, a game console, a laptop computing device, a tablet-type computing device, a smartphone or other kind of wireless telephone, a personal digital assist device, a music-playing device, a book-reader device, a wearable computing device, and so on.

FIG. 6 shows another implementation of the QPS 102 of FIG. 1. In this scenario, local computing functionality 602 is coupled to remote computing functionality 604 via one or more networks 606. In one case, the remote computing functionality 604 includes remote QPS functionality 608 which implements all aspects of the QPS system 102, in conjunction with one or more remote data stores 610. A user may interact with the remote computing functionality 604 using the local computing functionality 602 via the network(s) 606. In another case, the functions performed by the QPS 102 are distributed between the remote computing functionality 604 and local computing functionality 612. The local QPS functionality 612 runs on the local computing functionality 602, in conjunction with one or more local data stores 614.

In one technology-specific implementation, the local computing functionality 602 may provide a browser program. The user interacts with the functionality of the QPS 102 via the browser program, e.g., based on markup code and JavaScript code which are received from the remote computing functionality 604. In another case, the local computing functionality 602 stores a local application. The local application interfaces with the remote computing functionality 604 via application programming interfaces (APIs) or the like. Still other technology-specific implementations are possible.

The local computing functionality 602 may correspond to any computing device described above with reference to FIG. 5. The remote computing functionality 604 may correspond to one or more servers and associated data stores, provided at a single site or distributed among two or more sites. The network(s) 606 may correspond to a local area network, a wide area network (e.g., the Internet), point-to-point communication links, etc. or any combination thereof.

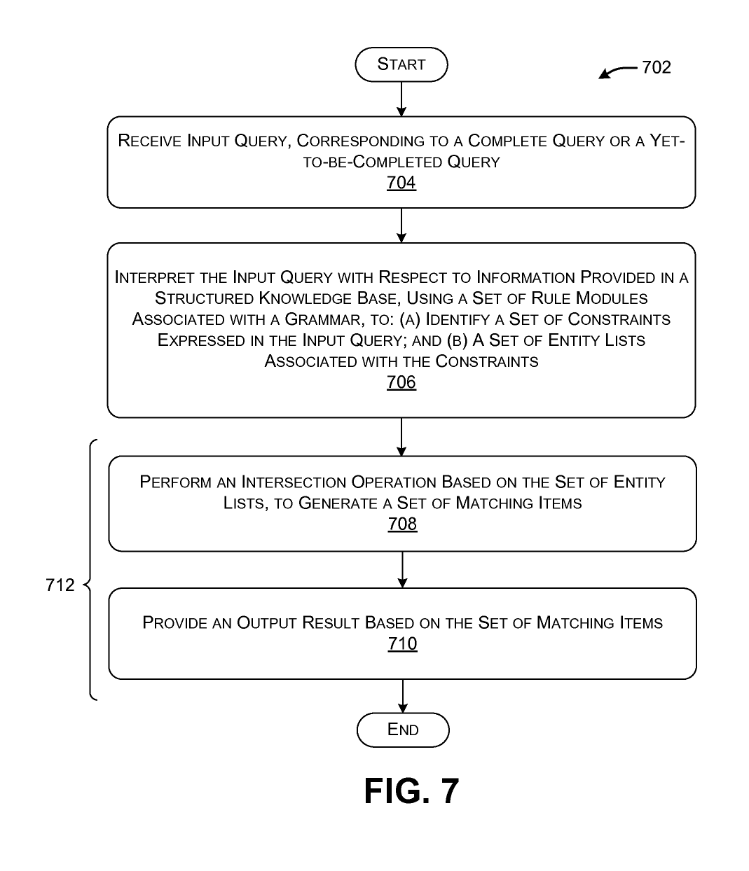

In conclusion to this introductory section, FIG. 7 shows a flowchart which summarizes the operation of the QPS 102 of FIG. 1, according to one implementation. In block 704, the QPS 102 receives an input query corresponding to a complete query or a yet-to-be-completed query. In block 706, the query interpretation module 110 interprets the input query with respect to information provided in the structured knowledge base. It performs this task using rule modules provided in the data store(s) 112, which collectively define a grammar. As a result of its processing, the QPS 102 generates a set of constraints expressed in the input query, along with a set of entity lists corresponding to the constraints. Section B provides additional information regarding block 706.

In block 708, the intersection module 118 performs an intersection operation on the entity lists generated in block 706, to generate a set of matching items. The intersection module 118 may optionally rely on pre-computed intersection information in the data store(s) 122 in performing this task. Section C provides additional information regarding block 708.

In block 710, the post-processing module 124 generates an output result based on the matching items identified in block 708. Block 710 may include extracting information using forward index information, analyzing the extracted information (and synonyms thereof) with respect to the user's original query, and so on. Section D provides additional information regarding block 710.

Stated in more general terms, blocks 708 and 710 correspond to an operation 712 of generating an output result based on the set of constraints identified in block 706.

B. The Query Interpretation Module

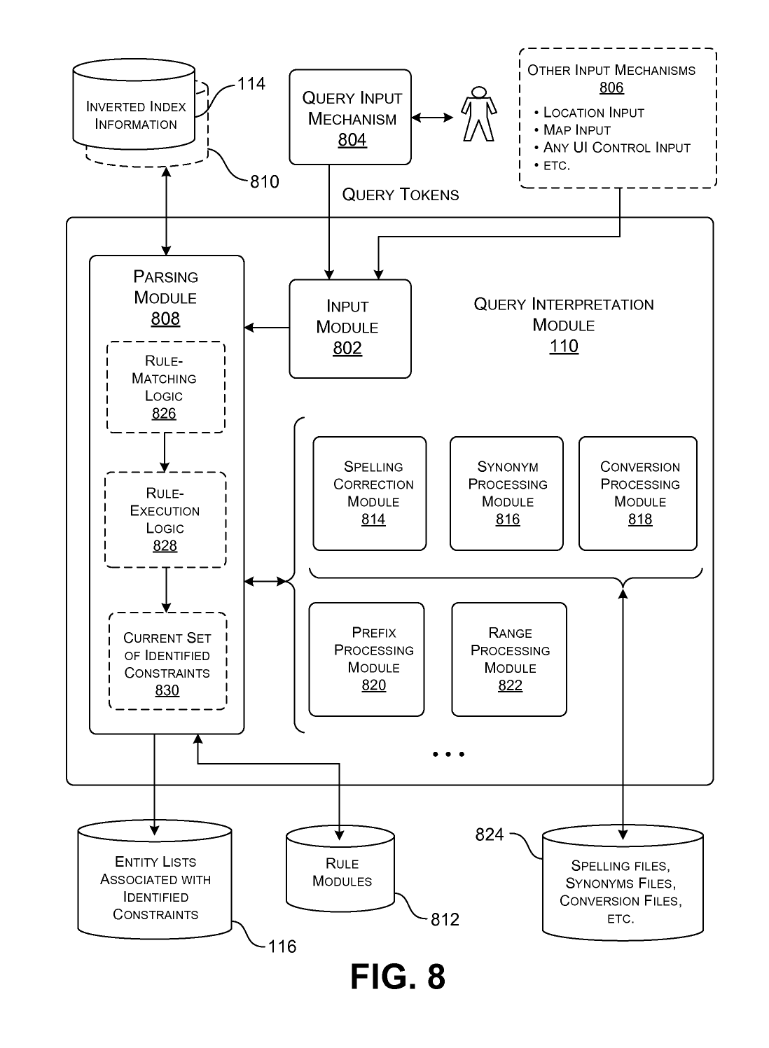

FIG. 8 shows one implementation of the query interpretation module 110. The query interpretation module 110 includes an input module 802 for receiving input information from one or more sources, such as a query input mechanism 804, and one or more other input mechanisms 806.

The query input mechanism 804 may correspond to a user interface presentation through which the user may enter a query that contains one or more terms, along with the input device(s) through which the user interacts with the user interface presentation. For example, the user interface presentation may provide mechanisms that allow the user to select the characters of the query in serial fashion, and/or by selecting terms from a drop-down menu or the like, and so on. The input devices can include a key input device, a mouse device, a touchscreen entry device, and so on, or any combination thereof. Alternatively, the input device may correspond to a voice recognition mechanism which detects the user's spoken query.

The other input mechanisms 806 allow the user to input information, which may have a bearing on the user's intent in performing a search, through any mode other than the specification of alphanumeric text. For example, the other input mechanisms 806 can include any other user interface mechanisms through which a user may specify a constraint, in a form other than an alphanumeric query, together with the input device(s) through which the user interacts with the user interface mechanism. For example, one such user interface mechanism may correspond to a graphical slider bar, button, knob, etc. through which the user may enter a value within an identified range. Another user interface mechanism may correspond to a map presentation. The user may select a region or a specific location on the map presentation, which operates as a location-based constraint on the search that is performed. For example, the user may input the term “Asian restaurants” via the query input mechanism 804, and then select a region on a map presentation corresponding to Seattle, Wash. (or vice versa). The QPS 102 will then attempt to retrieve results subject to those two constraints, which, if successful, will have the effect of omitting the presentation of Asian restaurants outside the Seattle region. The QPS 102 can dynamically modify the user interface mechanisms in response to the output result generated by the QPS 102, e.g., by adjusting the range associated with a slider bar based on the current query and its associated suggestions.

Other input mechanisms may collect input information in an automated manner, without interaction with the user. For example, the other input mechanisms 806 can include a location determination device for providing position data corresponding to the user's current location. The location determination device may correspond to a satellite-based location determination mechanism (e.g., GPS), a triangulation mechanism, a dead-reckoning mechanism, and so on. Or the location determination device can assess the user's position in general terms, e.g., based on his or her detectable proximity to a wireless access point or the like.

In addition, or alternatively, another input mechanism may correspond to a retrieval module which retrieves user-related information from one or more data stores. Such user-related information may include any data which may have a bearing on the user's current search intent. Such data may describe, for instance, the user's prior behavior (such as the user's prior query-submission history, purchase history, click selection history, etc.), the user's demographics, and so on. The QPS 102 utilizes user-related information, if at all, with the express permission of the user, and in compliance with applicable laws and societal norms and expectations.

In any case, the input query may be considered to represent the text information specified by the user via any input mode(s), together with any optional supplemental information which may have a bearing on the user's search intent.

A parsing module 808 operates as the central engine which analyzes the user's input query, at each instance of the user's input of that query. To perform this task, the parsing module 808 relies on various resources, such as: inverted index information provided in one or more data stores 114; the structured knowledge base provided in one or more data stores 810; a collection of rule modules provided in one or more data stores 812; a spelling correction module 814; a synonym processing module 816; a conversion processing module 818; a prefix processing module 820; a range processing module 822; spelling correction files, synonym files, conversion files, etc. stored in one or more data stores 824, and so on. Other implementations may include only a subset of the above-described resources, and/or may include additional resources not shown in FIG. 8. The parsing module 808 stores its analysis results, constituting a set of entity lists, in one or more data stores 116.

The spelling correction module 814, synonym processing module 816, and conversion processing module 818 may generate alternative versions of one or more terms in a user's input query. That is, for a given term in the user's input query, the spelling correction module 814 can generate one or more corresponding spelling-corrected input terms, e.g., to address the case in which the user may have misspelled the intended term, or to address the case in which the knowledge base itself contains misspellings. The synonym processing module 816 can generate synonyms of the input term. One type of conversion processing module 818 can determine one or more variations of the input term that are appropriate to different regions (or more generally, to different language-speaking domains or “markets”). Another type of conversion processing module can determine different interpretations of a phonetically-expressed word. In one implementation, any alternative term generated by the suite of modules (814, 816, 818) described above corresponds to an information item that actually appears at least once in the knowledge base.

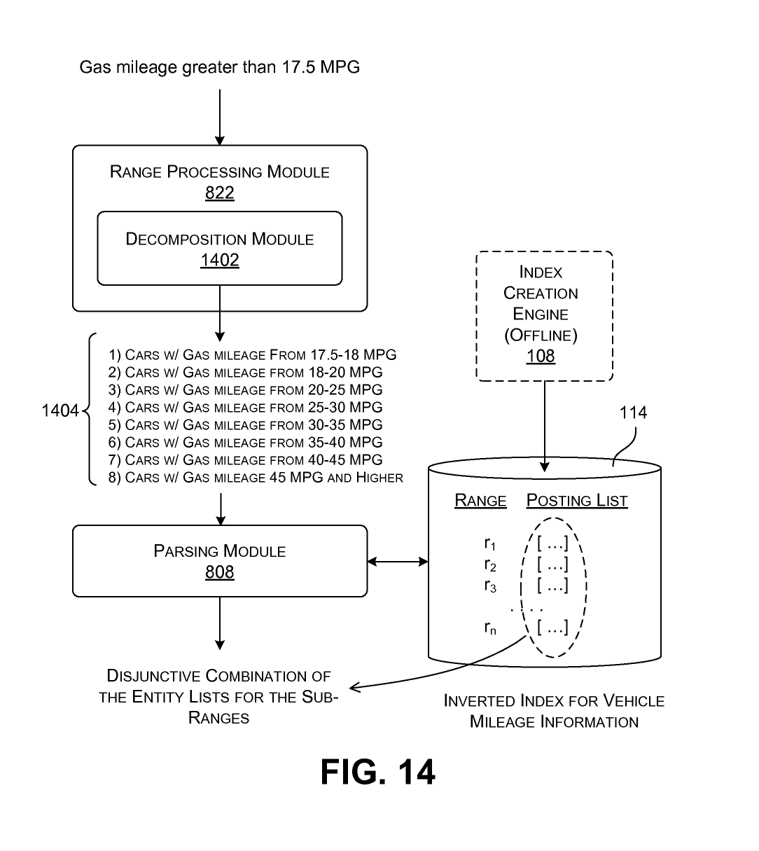

The prefix processing module 820 may fan out a prefix in the input query into one or more extended prefixes. The range processing module 822 performs a related function by decomposing a master range specified in the query into one or more sub-ranges. Additional explanation regarding these two modules (820, 822) is provided below, in the context of the description of FIGS. 14-16.

The parsing module 808 itself includes, or may be conceptualized as including, rule-matching logic 826, rule-execution logic 828, and a buffer 830. The rule-matching logic 826 determines whether patterns, specified in the rule modules, apply to a particular part of an input query under consideration. The rule-execution logic 828 executes behavior associated with the rule modules. Such behavior involves extracting information items from the knowledge base, such as entity items, attribute value items, entity scores, and so on. The buffer 830 stores information regarding a current set of postulated constraints.

Overall, as stated in Section A, the parsing module 808 operates by determining a set of the most likely paths through a space, defined by the grammar Each such path represents a complete candidate interpretation of the input query, and may encompass an extension of the input query (beyond what the user has currently specified). Any node along any such path represents a partial set of conclusions regarding an interpretation of the query. Further, any child node along a path, relative to a preceding parent node, represents a further refinement in the interpretation, relative to the preceding, parent, interpretation. In choosing how to refine an interpretation, the parsing module 808 is faced with the task of choosing among different possible candidate interpretations. The parsing module 808 examines several factors in making this decision.

First, the parsing module 808 can determine whether a candidate interpretation is applicable to the current input query—or, in other words, whether the interpretation is grammatical or legal. Assume that the candidate interpretation under consideration is associated with a particular rule module. And further assume that the rule module specifies a pattern that is expected to be present in the input query, in order for the rule module to be properly applied to the input query. The parsing module 808 can determine whether an interpretation is valid, in part, by determining whether the input query includes words that match the pattern specified in the associated rule module.

Assuming that the interpretation is legal, the parsing module may then take into consideration one or more scores that indicate the appropriateness of the interpretation. For example, the parsing module 808 can take into consideration applicable entity scores specified in the knowledge base. Consider an illustrative query, part of which specifies the name “Mt. Spokane.” The rule-matching logic 826 may determine that a place-finding rule module applies to this query, which, in turn, operates in conjunction with a table of place names. The rule-execution logic 828 can then examine the table of place names in the knowledge base to determine whether it actually contains such an entity item. If the knowledge base includes this entry, the rule-execution logic 828 can extract the entity score associated with the entry. As previously described, the entity score may reflect the popularity of an entity item, established in any manner. For example, for the entity score for the term “Mt. Spokane” may reflect how many times users have searched this term via a commercial search engine. A candidate interpretation having an underlying popular entity score is more probable, relative to an interpretation having an underlying unpopular entity score.

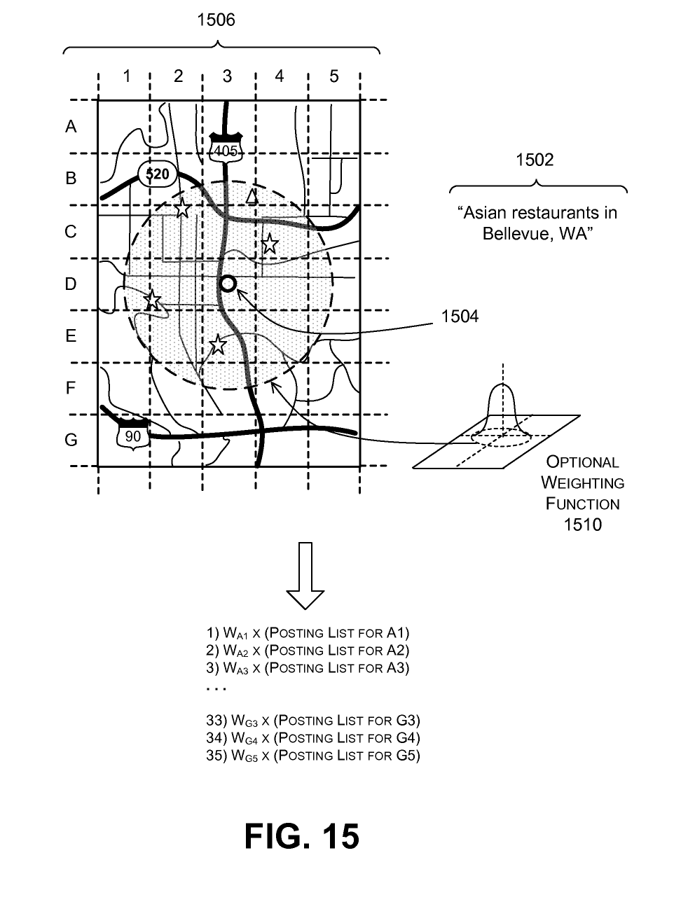

The parsing module 808 can also consider other scores in determining the appropriateness of a candidate interpretation. In another case, a weighting function can apply a weight to a candidate entity item, based on a relation between the candidate entity item and a reference point. For example, assume that the candidate entity item has a position value item that reflects a geographic position of the entity on a map. A weight can be applied to the candidate entity item that depends on a distance between the geographic position of the entity, as reflected by the position item value, and a reference position value (such as a center point of the map). This strategy can be used, for instance, to favor entity items that lie nearest to a focal point of interest. FIG. 15 and the accompanying explanation provide more information regarding this technical feature.

As another example of score information, the space defined by the grammar may annotate each transition, from one node to the next, with a grammar probability value that defines the likelihood of that transition. When choosing a particular candidate interpretation, relatively to a parent context, the parsing module 808 can take the probability value of that transition into account. That probability score may reflect, among other factors, the frequency at which this transition appears in queries. An offline engine can compute the probability values for all transitions in the space based on a training corpus of queries.

In addition, or alternatively, the parsing module 808 can assign one or more penalty scores to a candidate interpretation, if applicable. For example, assume that the user inputs “Suzooki” instead of the canonical name of the manufacturer, “Suzuki.” Further assume that the name “Suzooki” corresponds to valid manufacturer name, although not the intended manufacturer name. The parsing module 808 can consider both terms “Suzooki” and “Suzuki” as possible interpretations of the user's input query. But the parsing module 808 can assign a penalty score to “Suzuki,” because it varies from the term that the user actually specified. The interpretation that is based on “Suzooki” will not likely survive, however, as it will likely contradict other aspects of the user's input query, such as when the user inputs “automatic transmission,” yet the hypothetical manufacturer “Suzooki” produces kitchen equipment.

Similarly, assume that the user, who is operating in an American English-speaking locale, enters the term “Suzuki SX4 bonnet.” The parsing module 808 may take into consideration that the word “bonnet” refers to the hood of a car, as per a common British usage, but may discount the interpretation accordingly. The parsing module 808, however, would not assign this penalty had the user made the same inquiry from a UK-based locale. In other cases, a resident of a particular country may refer to a location, in that country, by one term, while a foreigner may refer to it by another. A user is penalized for a specified location name only if this name is at odds with common practice in the region from which the query is presumed to have been authored.

More precisely stated, note that a particular interpretation of an input query may occur in the nested context of one or more prior assumptions about the input query, as it currently exists. As such, the score assigned to any candidate interpretation may also reflect the scores associated with previous interpretations on which the current candidate interpretation depends. Such parent-level or ancestor level scores may incorporate any type of scores described above, such as entity scores (reflecting the popularity of entities), weighting scores, grammar probability scores, penalty scores (associated with spelling correction, synonym replacement, language conversion, etc.), and so on. In one example, a child-level interpretation can take into consideration parent-level (or ancestor-level) penalty scores by adding those scores to whatever incremental scores are associated with the child-level interpretation, to produce final scores.

For example, assume that the parsing module 808 is currently attempting to interpret the phrase “transmission,” which is added to a preceding phrase “Suzuki of road,” where the user has omitted the second “f” in “off” The parsing module 808 may consider the possibility that the user really intended to type “off-road,” but this is not the only meaningful interpretation. As such, the preceding interpretation of “Suzuki off-road” will receive a penalty score. It also receives an entity score that reflect the popularity of the term “Suzuki off-road.” Those parent-level scores carry forward to the overall scores that the parsing module 808 assigns to the further-refined input query “Suzuki of road transmission,” that is, in the particular context in which “of road” is interpreted as “off-road.” For instance, the parent-level scores may be added to whatever incremental scores are generated by adding the word “transmission” to the query.

With respect to the specific topic of penalty scores, the query interpretation module 110 can compute these values in any application-specific manner. For example, the spelling correction module 814 can determine the number of changes that need to be made to transform one form of a word into another form of the word. The spelling correction module 814 can then assign a penalty score which depends on the number of changes that need to be made. The conversion processing module 818 can add an additional penalty point if the two words that are being compared are associated with different natural language-speaking regions, such as an English market vs. a French market, a U.S. market vs. a British market, and so on. Further, as stated above, when considering a particular interpretation, the query interpretation module 110 can consider the penalty scores of any parent and/or ancestor interpretations, on which the current interpretation is predicated. These parent-level and/or ancestor-level scores carry forward into a determination of the penalty score of the interpretation currently under consideration.

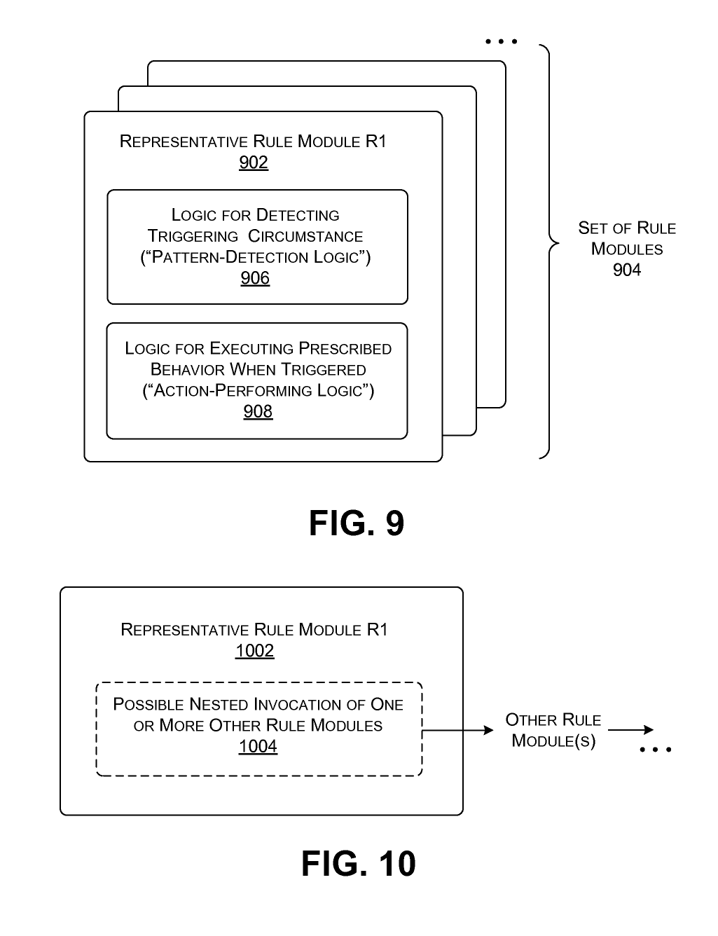

FIG. 9 is a logical depiction of a particular rule module 902, which corresponds to one rule module among a set of rule modules 904. To repeat, the collection of rule modules 904 collectively defines a space of legal queries that conform to a grammar.

The rule module 902 may include logic for detecting a circumstance that invokes the application of the rule module 902, referred to as pattern-detection logic 906. The pattern-detection logic 906 may specify a pattern in any manner, such as by specifying the text that will invoke the application of the rule. The parsing module 808 can compare that text against the query using any parsing method, e.g., using a Regex mechanism or the like. The pattern-detection logic 906 can also specify the technique to be used to detect the pattern. The rule module 902 may also include logic for executing prescribed behavior when the rule module has been invoked, referred to as action-performing logic 908. Each rule module may also include definition information (not shown), which describes other features of the rule module. For example, assume that a rule module is intended to apply to only a specific type of table or tables. The definition information may describe the table(s) to which the rule applies, referred to as segments.

More specifically, in one non-limiting implementation, a rule module may be built using functions drawn from a set of possible functions. A first function (Select) operates by retrieving a particular entity item from the knowledge base (e.g., as applicable to the query “Mount Rainier”). A second function (SelectMany) operates by retrieving plural entity items from the knowledge base (e.g., as applicable to the query “Tom Cruise action movies”). A third function (SelectValue) retrieves a single attribute value item associated with a single entity item (e.g., as applicable to the query “The height of Mount Rainier”). A fourth function (SelectManyValue) retrieves plural attribute values from plural entity items (e.g., as in the query “Heights of the tallest mountains”). A fifth function (Compare) yields a comparison between two or more results of the same type without any implied constraints between them (e.g., as in the query “Weather in Portland vs. Seattle”). A sixth function (SelectIntersection) provides an intersection (i.e., AND) between information items (e.g., as in “Mountains in WA that are volcanic”). A seventh function (SelectUnion) returns a union among information items (e.g., as in “red or black cameras”). An eighth function (CrossSelect) examines information items from two segments (e.g., tables) (e.g., as in “Portland bar”), where the information items may be individually ambiguous. Still other functions are possible.

Other programmatic features in a rule module may specify the order in which items are to be arranged, e.g., in ascending or descending order. Other features may specify a count applied to information items extracted from the knowledge base, and can allow the rule module to select one or more particular information items in a series of such items (e.g., by selecting the “third tallest,” etc.). Another feature allows a rule module to perform filtering on the basis of constraints that are specified through some mechanism other than the input query. Another feature allows a rule module to specify that certain conditions are expected to be met in order for some action to take place.

FIG. 10 shows a parent rule module 1002 that incorporates a reference 1004 to at least one child rule module. The child rule module may therefore be viewed as nested within the parent rule module 1002. Upon execution, the child rule module provides an output result. The parent rule module 1002 performs a function that is dependent on an output result generated by the child rule module. More generally, a rule module can invoke a chain of nested rule modules of any length. For example, the child rule mode in FIG. 10 can, in turn, invoked its own child rule module.

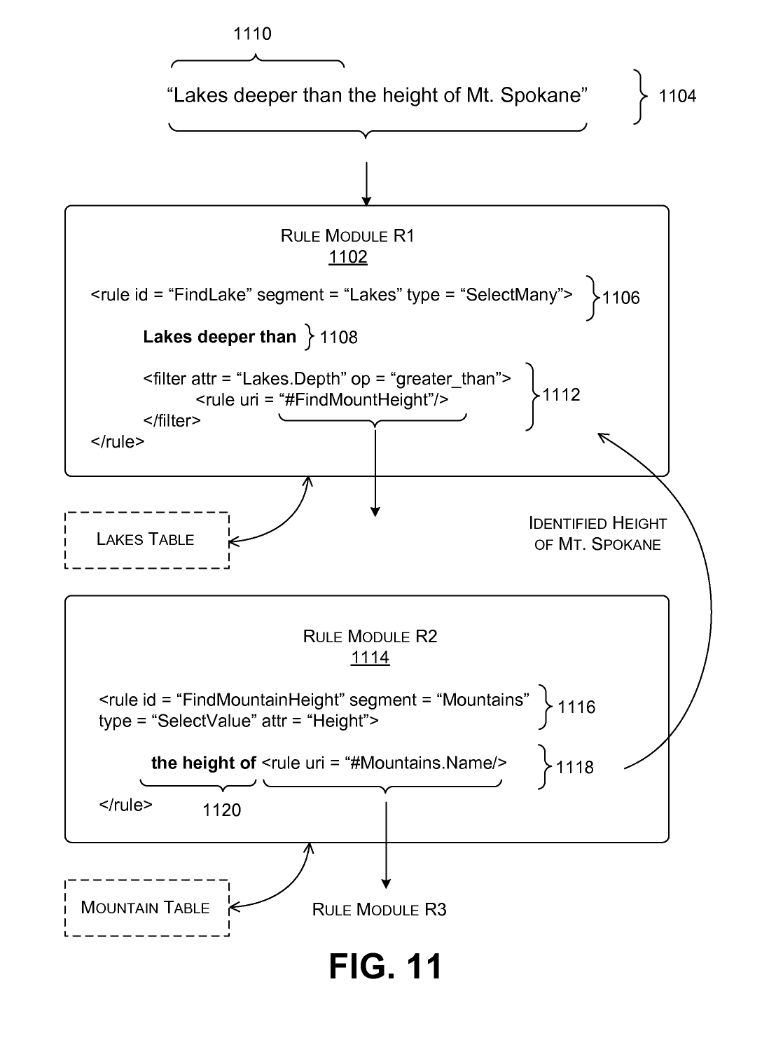

FIG. 11 shows an example of a rule module (R1) 1102 that can be successfully applied to the illustrative query 1104 that reads, “Lakes deeper than the height of Mt. Spokane.” The rule module 1102 is an example of the type of rule module described with reference to FIG. 10. More specifically, as indicted by the header information 1106, this rule module 1102 applies to a “Lakes” table, and leverages the “SelectMany” function, insofar as it specifies a request to retrieve lakes that meet a certain numeric constraint. But that numeric constraint is specified in an indirect manner, e.g., by specifying a lower-bound value that is equivalent to the height of “Mt. Spokane,” a mountain in Eastern Washington state.

A program element 1108 specifies a pattern which will invoke the application of the rule module 1102. That pattern corresponds to the phrase “Lakes deeper than,” which matches a portion 1110 of the input query 1104. In other cases, the rule module 1102 can specify the pattern in a more flexible manner, e.g., by including plural variants of the pattern, or by otherwise incorporating any type of fuzzy matching provisions.

A program element 1112 executes the behavior of the rule module 1102, which entails extracting a set of lake names from the lakes table that meet the specified criterion. To perform this task, the program element 1112 calls a child rule module (R2) 1114 via a reference to the child rule module 1114.

The child rule module 1114 includes header information 1116 which identifies that it is configured to extract a single height value from an entity item that appears in a mountain-related table (e.g., by virtue of it being a SelectValue-type function, directed to the attribute “Height”). The child rule module 1114 includes a program element 1118 that provides logic for extracting the height of a specified mountain name, e.g., by calling yet another rule module (R3). The program element 1118 also specifies a pattern 1120 that will invoke the child rule module, that is, corresponding to the phrase “the height of” The child rule module 1114 returns the extracted height value to the parent rule module 1102, whereupon the parent rule module 1102 uses the height value as a lower-bound value in identifying qualifying lake names.

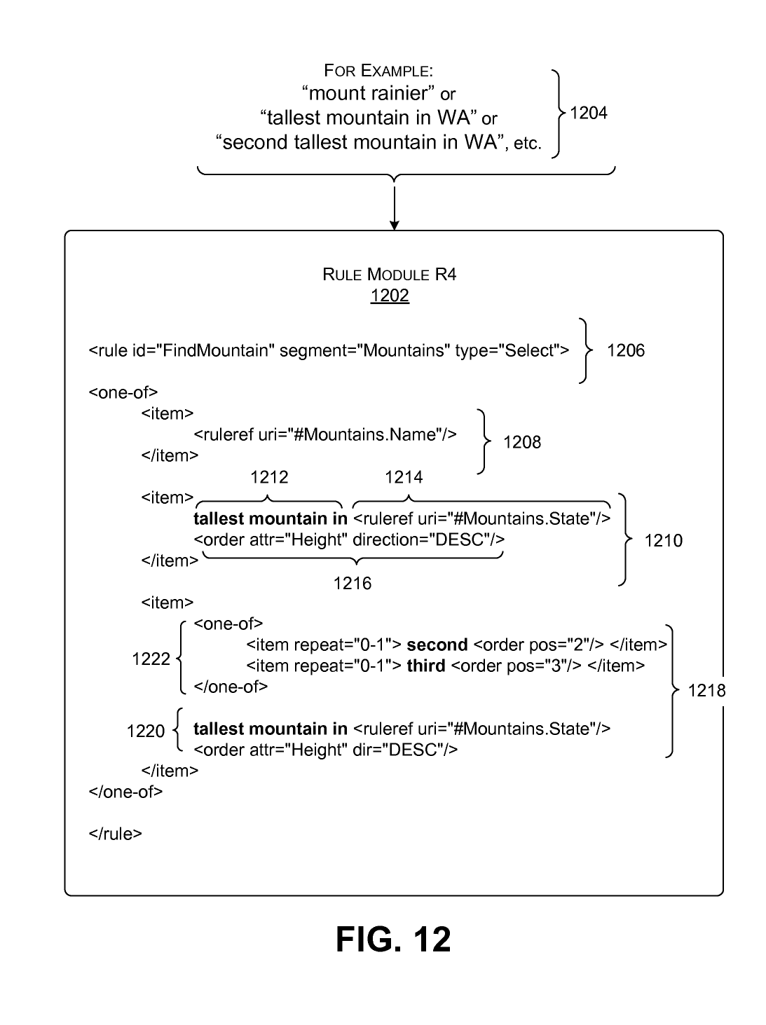

FIG. 12 shows another rule module (R4) 1202 that processes some mountain-related queries, such as the illustrative queries 1204. As indicated by header information 1206, the rule module 1206 performs the task of selecting mountain entities by operating on a mountain-related table.

A part 1208 of the rule module 1202 handles the scenario in which the user simply inputs the name of a mountain, as in “Mount Rainier.” It performs this task by invoking a nested rule; that nested rule, in turn, makes an appropriate inquiry to the mountain-related table, based on the specified mountain name.

A part 1210 of the rule module 1202 handles the scenario in which the user asks for the tallest mountain in a particular state, as in the query, “tallest mountain in WA.” A program element 1212 defines one pattern that will trigger the application of part 1210 of the rule module 1202. A program element 1214 queries a collection of mountains in the specified state, by invoking a nested rule module. A program element 1216 provides an instruction to select the mountain having the maximum height; by default, the number of entities returned is one, corresponding to the tallest mountain.

A part 1218 of the rule module 1202 handles the scenario in which the user asks for a particular mountain in a list of mountains (other than the tallest), as when the user asks for the “second tallest mountain in WA.” A program element 1220 performs the same function described above with respect to part 1210. A program element 1222 instructs the parsing module 808 to select the second or third mountain in the list of mountains identified by the program element 1220, depending on whether the input query contains the words “second” or “third,” etc.

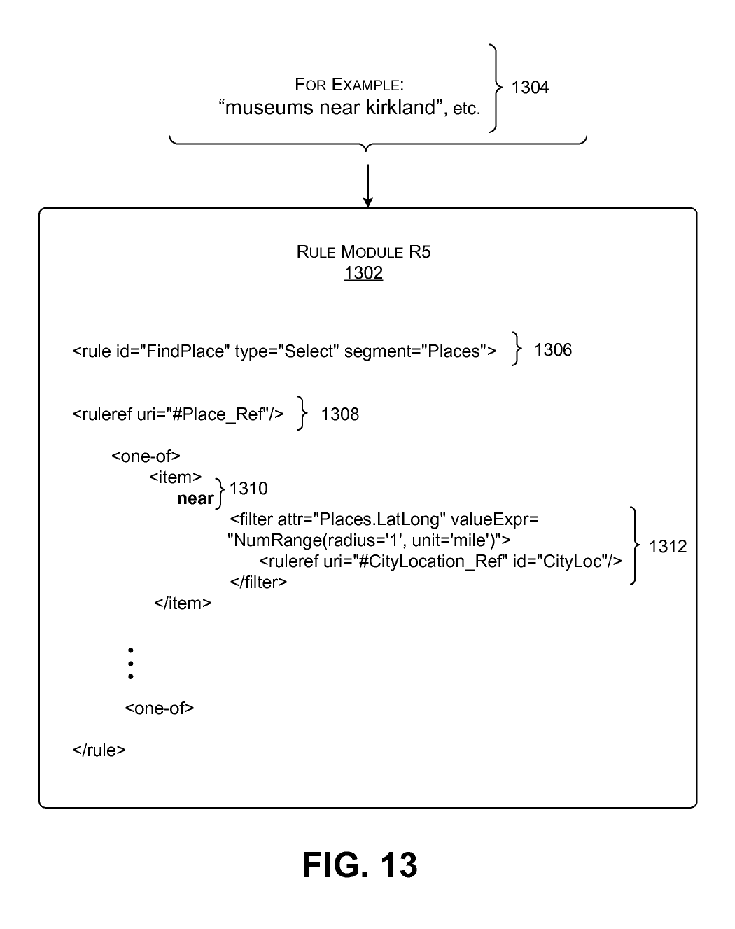

FIG. 13 shows a rule module (R5) 1302 that process a proximity-type of query 1304 that reads, for example, “museums near kirkland.” A program element 1306 indicates that this rule module 1302 is designed to select places from a place-related table. A program element 1308 invokes a nested rule module which determines the type of place specified by the user's query, e.g., “museums” in this case. A program element 1310 specifies one pattern (e.g., in this non-limiting case, a pattern including the word “near”) which invokes the application of the rule module 1302. A program element 1312 instructs the parser module 808 to retrieve museums that lie within a mile radius of a center point associated with the city of Kirkland, Wash. The center point of the city of Kirkland, in turn, is determined by invoking another nested rule.

In general, the rule modules (1102, 1202, 1302) described above are examples of numeric constraint rule modules, insofar as these rule modules express constraints that are numeric in nature. The numeric nature of these constraints can be expressed in words (e.g., “tallest,” “near,” etc.) and/or numbers.

Advancing to FIG. 14, this figure shows one implementation of the operation of the range processing module 822, in conjunction with the parsing module 808. Assume that the parsing module 808 receives a query that reads, “Gas mileage greater than 17.5 MPG.” The intent of the user in this case may be to identify car models that offer gas mileage greater than 17.5 miles per gallon. This numerical constraint is referred to below as a master range.

The range processing module 822 leverages a decomposition module 1402 to decompose the master range into plural sub-ranges 1404, such as a first range from 17.5 to 18, a second range from 18-20, a third range from 20-25, a fourth range from 30, 35, and so on. The parsing module 808 treats these sub-ranges as if they were expressed in the original query instead of the master range. As such, the parsing module 808 may generate an entity list for each of the sub-ranges, such as a first entity list for the first sub-range, a second entity list for the second sub-range, and so on. The QPS 102 may then form a master set of entity lists which comprises a disjunctive combination of the individual entity lists associated with the individual sub-ranges.

To function as described, the index creation engine 108 stores, in an offline preliminary process, entity lists for the identified sub-ranges. More specifically, in some implementations, the index creation engine 108 can store entity lists for segments of a master range, where the segments can have any size or sizes. The index creation engine 108 can also store one or more catch-all segments, such as by allocating a top-end segment that stores all entity items above a certain upper-bound value, and/or allocating a bottom-end segment that captures all entity items below a certain lower-bound value.

In other implementations, the index creation engine 108 can store entity lists for a hierarchical collection of sub-ranges. For example, the index creation engine 108 can store a collection of entity lists for segments of a first size (or sizes), a second collection of entity lists for segments of a second size (or sizes) (where the second size is larger than the first size), a third collection of segments having a third size (or sizes) (where the third size is larger than the second size), and so on. For example, for a master range from 0 to 100, a first tier of segments can include ten contiguous segments, each having a width of ten. A second tier of segments can include five segments, each having a width of twenty. A third tier can include two segments, each having a width of fifty, and so on. Still other strategies of parsing a master range are possible. For instance, the hierarchy can have any number of tiers.

In in one implementation, a larger segment can store its entries in an independent fashion from the smaller segments, which it encompasses. Alternatively, a larger segment can make reference to the smaller encompassed segments, without actually duplicating the entries within those smaller segments. Still other data structures may be used to economically store entries in overlapping segments.

In real time operation, the decomposition module 1402 chooses the collection of sub-ranges such that, when considered all together, the sub-ranges fully canvas the master range. The decomposition module 1402 will also seek to choose sub-ranges which avoid (or which minimize) occurrences in which sub-ranges overshoot the target master range. In some cases, the decomposition module 1402 can choose among two or more groups of sub-ranges which meet the above criteria. In that case, the decomposition module 1402 can choose the group having the minimum number of sub-ranges.

In the example of FIG. 14, the master range corresponds to a range of numerical values demarcated at one end by a lower-bound threshold. But, more generally, the strategy described with reference to FIG. 14 can be applied to any numerical constraint of any type, or, indeed to any constraint that can be decomposed into smaller constraints. Generally, the range processing module 822 may be said to break a master constraint into one or more smaller sub-constraints. The sub-constraints are expected to: (a) fully canvas the master constraint; (b) minimize coverage outside the bounds of the master constraint; and (c) canvas the master constraint in the most economical manner possible, e.g., using the fewest number of sub-constraints.

FIG. 15 illustrates another application of the strategy set forth in FIG. 14. In this example, the user specifies a geographical region as part of his or her inquiry. The user can perform this task in any manner, such as by specifying the name of a city, landmark, or region in his or her input query 1502. Alternatively, or in addition, the user can point to the center 1504 of the region on a graphical map presentation 1506. Alternatively, or in addition, the user can trace the border of the desired region on the map presentation 1506, and so on. Assume here that the designated region generally corresponds to the city of Bellevue, Wash. The user has also specified another query term, namely “Asian restaurants.” Overall, the intent of the user is to locate restaurants of the Asian genre in the city of Bellevue.

Assume that, in an offline process, the index creation engine 108 stores inverted index information for a map, with respect to component sub-regions in the map. Each smaller region includes a prescribed range of latitude values and a prescribed range of longitude values. In a restaurant-finding context, assume that the index creation engine 108 stores an entity list for each sub-region which identifies all the restaurants in that sub-region. The index creation engine 108 can create and store other index information for other search-related context. In the context of FIG. 15, assume that the map presentation 1506 corresponds to one portion of the overall map. That map includes 35 of the sub-regions of the overall map, as demarcated by dashed lines. Each sub-region may be referenced, for explanation, purposes, by a combination of row and column numbers.

In response to the user's inquiry, the range processing module 822 (of FIG. 12) can decompose the designated map region into above-described 35 sub-regions. The parsing module 808 can then extract entity lists for those 35 regions. To repeat, each entity list may store entity items corresponding to restaurants located in a corresponding sub-region. The range processing module 822 can then form a master entity list which comprises a disjunctive combination of the entity lists for the individual sub-regions. The QPS 102 can then proceed in the manner set forth above, e.g., by intersecting the master entity list with the entity list (or lists) associated with the term “Asian restaurants.” The eventual output result will identify the existence and locations of Asian restaurants within the city of Bellevue.

In addition, the range processing module 822 can optionally use a weighting function 1510 to apply a weight to each position value in the map, to achieve any application-specific objective. For instance, the weighting function 1510 can be used to boost the relevance of position values relative to their respective distances from a designated reference point, e.g., such that position values closest to the reference point receive the highest boosting weights.

In the context of FIG. 15, the range processing module 822 can use the weighting function 1510 to apply a weight to each sub-region shown in FIG. 15 (and each posting list associated with the sub-region), where that weight may depend on the average distance of points in that sub-region to the center 1504. Alternatively, the QPS 102 can apply a weight to each individual restaurant item in a sub-region, e.g., based on the position value associated with that restaurant, as maintained in the knowledge base. In any case, the QPS 102 can employ this strategy to boost the relevance of restaurants that lie close to the “center point” of the user's geographical interest, while not outright excluding restaurants that match the user's interest in Asian cuisine, but which are relatively far from the center 1504. The “shape” of the weighting function can be chosen to apply any desired degree of de-emphasis to such outlying entities. In other cases, the user can define user-specific masks that serve to boost the relevance of certain map regions and/or de-emphasize the relevance of other map regions, e.g., as when a user strongly disfavors a certain part of a city.

The strategy described in FIGS. 14 and 15 can be applied to many other applications. For example, the strategy can be applied to data sets of any nature, such as data sets describing image content. The strategy can also be applied to data sets of any dimension, such as three or more dimensions.

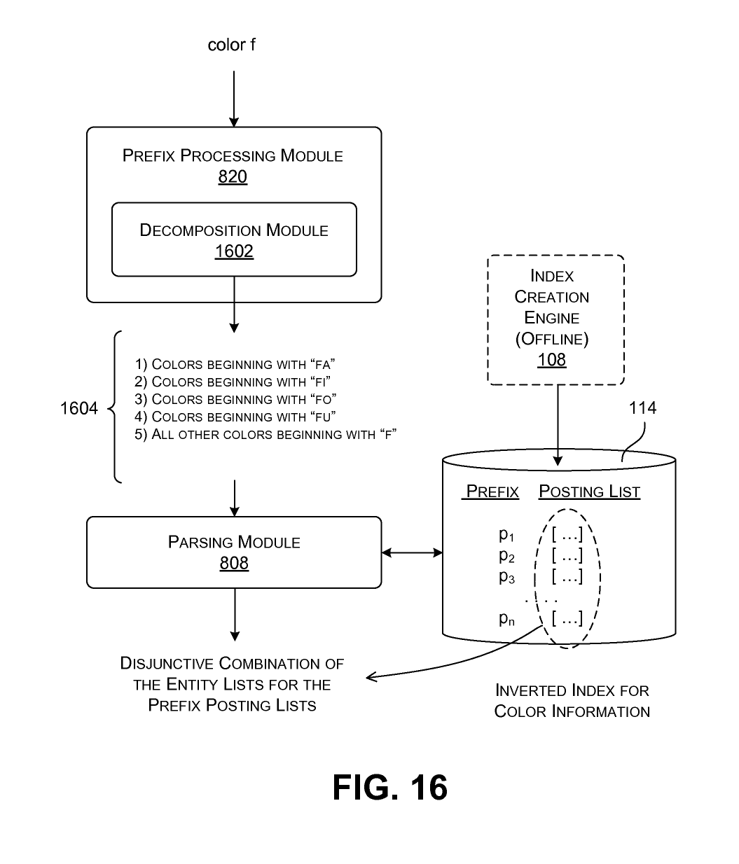

FIG. 16 shows one implementation of the prefix processing module 820 of FIG. 8. Assume that the prefix processing module 820 receives an input query that includes an originally-specified prefix, as in the illustrative input query “color f”. The prefix in this case specifies just the first character (“f”) of the word. In other cases, a prefix may include two or more initial characters of the word. In another case, the prefix is considered to include zero initial characters. In another case, the prefix may correspond to any number of initial characters of a multi-word term or phrase, as in the incomplete term “hewlett p”. In the particular scenario shown in FIG. 16, assume that the user is attempting to locate cars which are available in a color that starts with the character “f.” For example, one matching entry may identify the Ford Ranger, a pickup truck that is available in the color “forest green.”

The prefix processing module 820 can leverage a decomposition module 1602 to fan out the originally-specified prefix (“f”) into two or more extended prefixes, if necessary. For example, the decomposition module 1602 can fan out the originally-specified prefix into a first extended prefix which begins with “fa,” a second extended prefix that begins with “fi,” a third extended prefix which begins with “fo,” and so on, to yield a set of extended prefixes 1604. In other cases, an extended prefix can be created by adding two or more characters to the originally-specified prefix.

Again assume that the index creation engine 108 complements the operation of the decomposition module 1602, e.g., by storing, in advance, entity lists for the extended prefixes in the set 1604. In this particular and non-limiting context, assume that each entity list identifies entities having colors names which begin with the identified extended prefix, such as “fa.” Other implementations can create prefix-related partitions based on any other criteria.

In processing the query, the prefix processing module 820 can next form a master entity list which comprises a disjunctive combination of the entity lists for the individual extended prefixes. The QPS 102 can intersect the master entity list with the entity list (or lists) associated with any other terms in the user's query. The eventual output result will identify the existence of vehicles that meet the user's specifications, including the request that the vehicles' color begins with the character “f.”

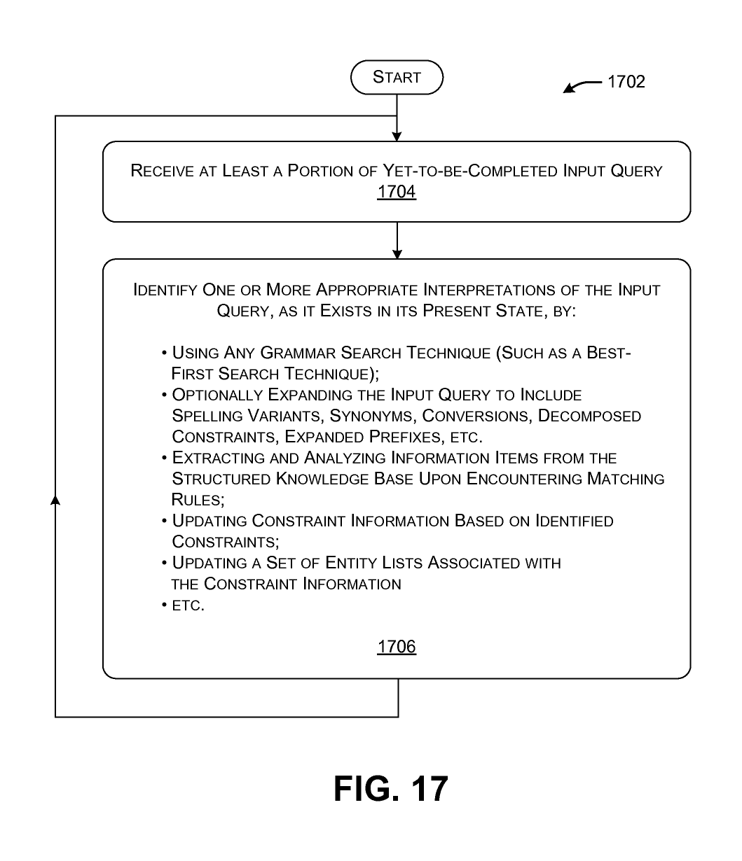

The remaining figures in this section summarize the above description with reference to a series of flowcharts. To begin with, FIG. 17 shows a process 1702 which summarizes the operation of the query interpretation module 110. In block 1704, the query interpretation module 110 receives a yet-to-be-completed input query in its current state, or the entire completed input query. In block 1706, the query interpretation module 110 identifies one or more appropriate interpretations of the input query, as it exists in its present state. The process 1702 repeats until the user completes his or her query. The QPS's interpretation of the query will likely change as the user continues to add query terms to the query.

The bullet points in block 1706 identify illustrative features of the processing that may be performed by the query interpretation module 110. The first point indicates that the query interpretation module 110 can use any search technique to traverse the grammar defined by the rule modules, such as a best-first search (e.g., the A* search algorithm). In the A* search technique, the query interpretation module 110 identifies a best high-level interpretation, and then selectively expands that interpretation to provide the best refinement of that interpretation. It repeats this “lazy” expansion by successfully expanding the best interpretation until one or more complete paths are identified through the grammar space.

The second point indicates that the query interpretation module 110 can optionally expand the input query to include spelling variants of query terms, conversions of query terms, synonyms of query terms, decompositions of numeric constraints, fan outs of extended prefixes, and so on.

The third point indicates that the query interpretation module 110 operates by extracting and analyzing information from the knowledge base, using the inverted index information. The query interpretation module 110 performs this task to determine whether interpretations are viable. A viable interpretation is one that is supported by corresponding information in the knowledge base, and which is consistent with other constraints in the query. The query interpretation module 110 also mines the knowledge base to extract entity scores which are used, in part, to determine the appropriateness of competing candidate interpretations.

The fourth point indicates that, as a result of the above-described processing, the query interpretation module 110 updates the set of constraints which it posits are present in the input query. The fifth point indicates that the query interpretation module 110 stores a set of entity lists for the constraints that it has identified.

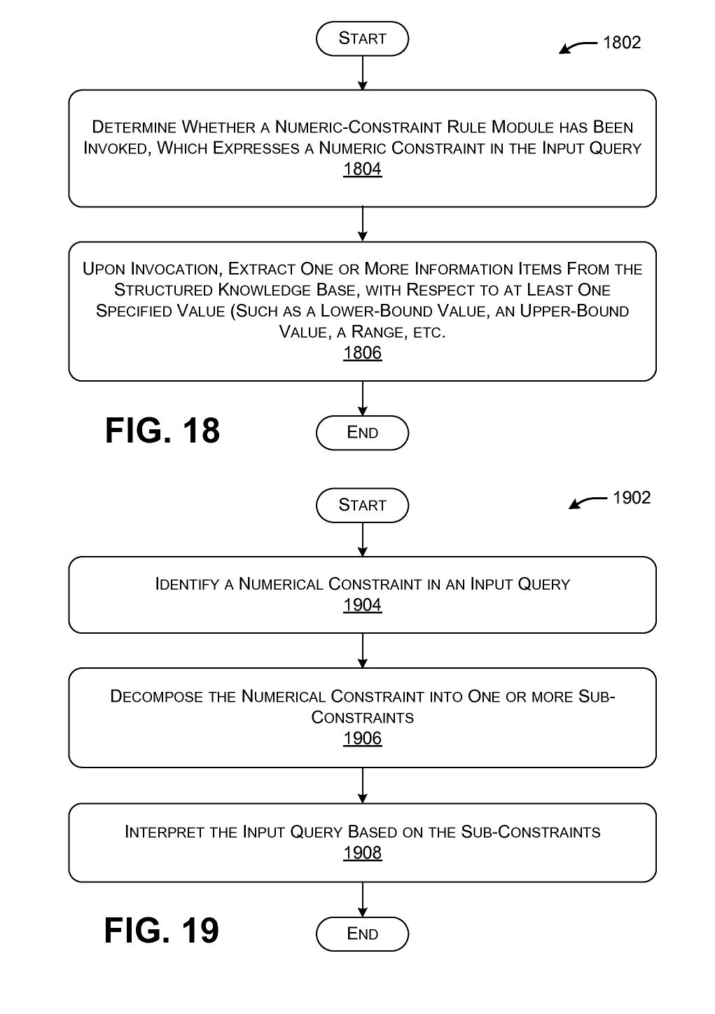

FIG. 18 describes a procedure 1802 for processing any type of numeric constraint in the input query. In block 1804, the query interpretation module 110 determines whether a numeric-constraint rule module has been invoked. A numeric-constraint rule model is a rule model that is configured to process a numeric constraint in the input query. Block 1804 may entail determining whether a pattern associated with the numeric-constraint rule module is present in the input query.

In block 1806, the query processing module uses the invoked numeric-constraint module to extract one or more information items from the structured knowledge base, in conformance with the numeric constraint in the input query. The information items may correspond to one or more entity items (such as the names of lakes), one or more attribute value items (such as the depths of the lakes), etc. The numeric constraint may specify a single-bound value, such as a lower-bound threshold value or an upper-bound threshold value, or a range of values demarcated by both a lower-bound value and an upper-bound value, or some other numeric relation.

In other cases, a numeric-constraint rule may operate to identify single values. For example, a numeric-constraint rule can identify a particular date that is present in the input query, or a specific temperature value, or a specific location value, and so on.

FIG. 19 shows a process 1902 which represents one manner of operation of the range processing module 822 of FIGS. 8 and 14. In block 1904, the parsing module 808 identifies a numeric constraint in the input query that is capable of being decomposed into smaller sub-constraints. In block 1906, the range processing module 822 decomposes the master constraint into two or more sub-constraints. In block 1908, the parsing module 808 interprets the input query based on the sub-constraints, rather than the master constraints. Block 1908 entails extracting entity lists corresponding to the individual sub-constraints.

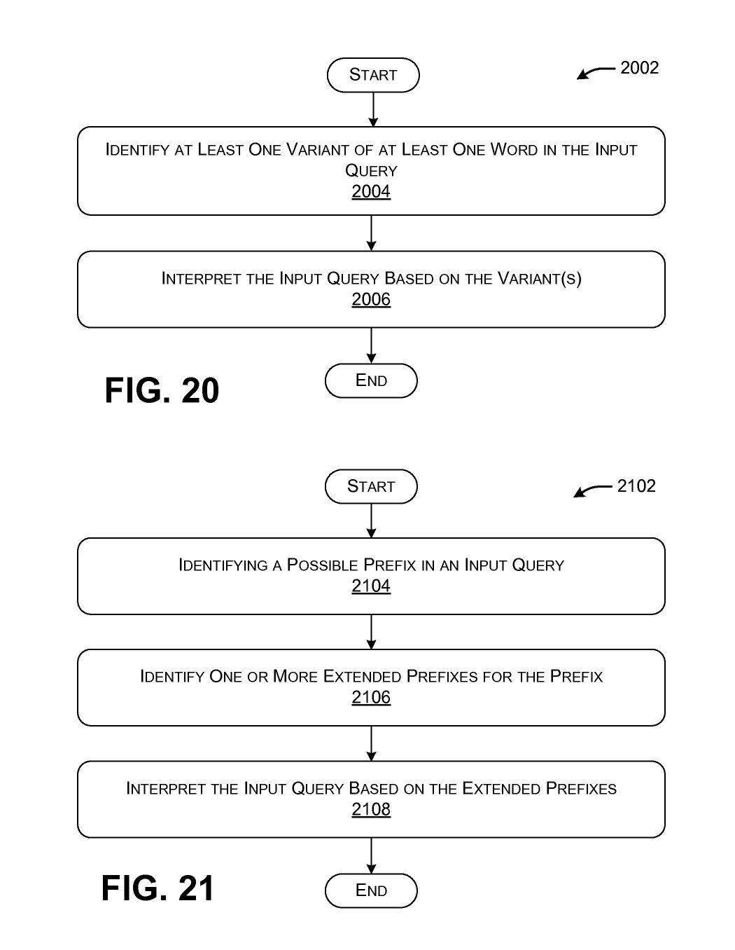

FIG. 20 describes the operation of any of the spelling correction module 814, the synonym processing module 816, or the conversion processing module 818. In block 2004, any of the above-mentioned modules identifies at least one variant of at least one term in the input query. In block 2006, the parsing module 808 interprets the input query based on the variant(s) identified in block 1804. Block 2006 may entail generating an entity list for each variant identified in block 2004.

FIG. 21 shows a process 2102 which represents one manner of operation of the prefix processing module 820 of FIGS. 8 and 16. In block 2104, the parsing module 808 identifies a possible prefix in the input query, corresponding to a character or characters which begin a word or multi-word term or phrase that has not been completed. In block 2106, the prefix processing module 820 optionally breaks the originally-specified prefix into two or more extended prefixes to match pre-computed entity lists in the inverted index information. Each extended prefix adds one or more characters to the originally-specified prefix. In block 2108, the parsing module 808 interprets the input query based on the extended prefixes, rather than the original prefix. Block 2108 entails extracting entity lists corresponding to the extended prefixes.

C. The Intersection Module

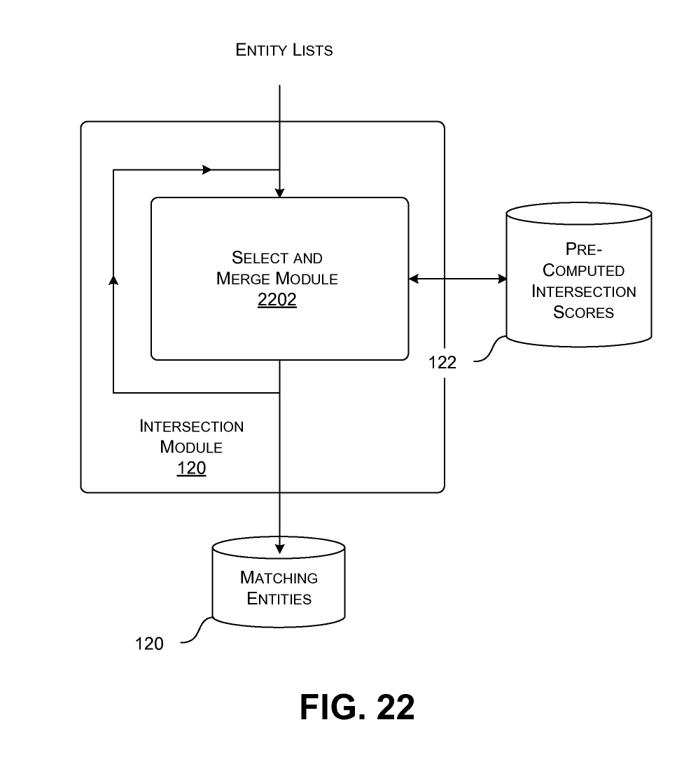

FIG. 22 shows one implementation of the intersection module 118. To repeat, the intersection module 118 performs an intersection operation on the entity lists identified by the query interpretation module 110, stored in the data store(s) 116. As a result of its processing, the intersection module 118 stores a set of matching entities in the data store(s) 120.

As a preliminary topic, each matching item produced by the intersection module has a combined score. The combined score may depend on any of the scores described above. For example, again consider the simplified example in FIG. 3. The matching item for entity item No. 13 originates from the intersection of the first entity list and the second entity list in the set of entity lists 304. Assume that the entity item No 13 has an entity score x, the first entity list has a score y, and the second entity list has a score z. The combined score of the matching item, for item No. 13, may correspond to the sum of these scores, e.g., x+y+z, or some weighted combination of these scores. Here, a high score indicates a desirable score, but this is a matter of application-specific convention; instead, a low score could represent a desirable outcome.

To revisit an earlier explanation, an entity score may correspond to the popularity level of the entity item, assessed in any manner. A desirable (high) entity score may correspond to an entity in which many people have previously expressed an interest. Although not represented in the above example, the combined score can also take into account a weight applied to the entity item, having any application-specific connotation.

The penalty score of an entity list may generally reflect the degree to which the matching term, on which the entity list is predicated, varies from the originally-specified counterpart of that term, as it appears in the input query. A desirable penalty score may indicate that the input term has not been significantly altered. For example, assume that a match with an entity item is procured by first performing spelling correction on the input term and/or by choosing a synonym of the entity item; the entity list, associated with the matching item, would be assigned a less favorable penalty score compared to the case in which no modification of the input term was performed to procure the match. The penalty score may be computed in the manner described earlier, or in any other application-specific manner.

The intersection module 118 attempts to identify a subset of matching items that have high (i.e., desirable) scores. One way to achieve this outcome is to exhaustively intersect all permutations of the entity lists. For example, assume that the complete intersection task involves intersecting a first set of three entity lists (which are disjunctively combined together to form the first master set) with a second set of five entity lists (which are disjunctively combined together to form the second master set). In other words, if the symbols A and B represent the two master sets, the complete intersection operation corresponds to (A₁ OR A₂ OR A₃) AND (B₁ OR B₂ OR B₃ OR B₄ OR B₅). This intersection task consist of 15 separate intersections, e.g., including (A₁ AND B₁), (A₁ AND B₂), . . . , (A₃ AND B₄), and (A₃ AND B₅). Moreover, note that, in actual practice, an intersection task may include many more intersections, with each entity list potentially include a large number of entity items, potentially many hundreds of thousands. After the complete set of matching items have been identified, the intersection module 118 can cull the n matching items having the highest (most desirable) entity scores.

The above approach is resource intensive, and can thus potentially negatively affect the responsiveness of the user interface of the QPS 102. To address this issue, the intersection module 118 can employ one or more provisions designed to speed up the intersection operation. As a first provision, an offline process can pre-compute the intersection of certain entity lists, such as those intersections which yield a number of matching items over a prescribed number K. The offline process can then store, for each such intersection, the highest score associated with the matching items produced by the intersection, and/or any other information pertaining to the intersection.

In the real time query processing phase, a selection and merge module 2202 can determine whether it is worthwhile to perform an intersection between two or more candidate entity lists by examining the pre-computed score associated with this intersection, if it happens to exist in the data store(s). The selection and merge module 2202 can then determine whether the score is high enough, relative to the known matching scores of other candidate intersections, to warrant performing the intersection.

As a second provision, the selection and merge module 2202 can employ any search strategy to attempt to find the combinations of entity lists that will yield the most favorable combined scores, without exhaustively exploring all possible intersections. For example, the selection and merge module 2202 can use any best-first search strategy to perform this task to find a shortest path through a space defined by all the possible combinations in the intersection operation. One best-first search strategy that can be used is the A* search algorithm, which, as described above, is a type of lazy expansion technique.

Consider one illustrative implementation of the selection and merge module 2202 in the context of the above example, which involves exploring fifteen candidate intersections between two disjunctive combinations, e.g., (A₁ AND B₁), (A₁ AND B₂), . . . , and (A₃ AND B₅). In other cases, any individual intersection can involve more than two entity lists. Further assume that each entity list stores a list of entity items (“items” for brevity below) in order of desirability, e.g., reflecting the entity scores assigned to the items, from most desirable (on the top of the list) to least desirable (on the bottom). This means that, when scanning down any two lists (such as A₁ AND B₁) from top to bottom, the first-encountered item that is shared by both lists will be the most desirable matching item that can be produced by intersecting those two lists.

In an initial operation, the select and merge module 2202 finds the first common item in each intersection of item lists, starting from the top of the lists. For example, with respect to the combination of (A₁ AND B₁), the select and merge module 2202 can scan down from the respective tops of both of these two lists until it finds an item that is common to both lists. The select and merge module 2202 can then identify the score associated with this matching item, computed in the manner described above. The select and merge module 2202 performs the same procedure with respect to each of the other intersections of entity lists, e.g., up to and including the last intersection of entity lists, (A₃ AND B₅). The select and merge module 2202 then picks the matching item that has the best score across all intersections of entity lists, and adds this matching item to the data store 120. This matching item constitutes the first-identified matching item.

The first-identified matching item will have originated from a particular intersection of entity lists. For example, assume, in one merely illustrative case, that it originates from the pairing (A₂ AND B₃). For that particular pairing, the select and merge module 2202 scans further down the lists until it identifies the next matching item, and its associated score. The select and merge module 2202 then repeats the task of picking the most desirable matching item across all the possible intersections of entity lists. The most desirable matching item at this stage may originate from any intersection of entity lists, not necessarily the particular intersection of entity lists that produced the first-identified matching item. The select and merge module 2202 adds the new matching item to the data store 120, constituting a second-identified matching item.

In general, the select and merge module 2202 can repeat the above procedure until it has collected a required number n of matching items. From a high-level perspective, the process involves picking matching items off the tops of the respective intersections of entity lists, e.g., by starting at the tops of the lists and successively moving down the lists, performing intersection in an as-needed and on-demand fashion. By collecting matching items in this manner, the select and merge module 2202 can forgo a large amount of work, compared to the previously-described implementation in which each intersection of entity lists is intersected in its entirety. In some cases, the select and merge module 2202 can also leverage the pre-computed scores in the data store 122 to further expedite at least the initial stage of the intersection procedure.

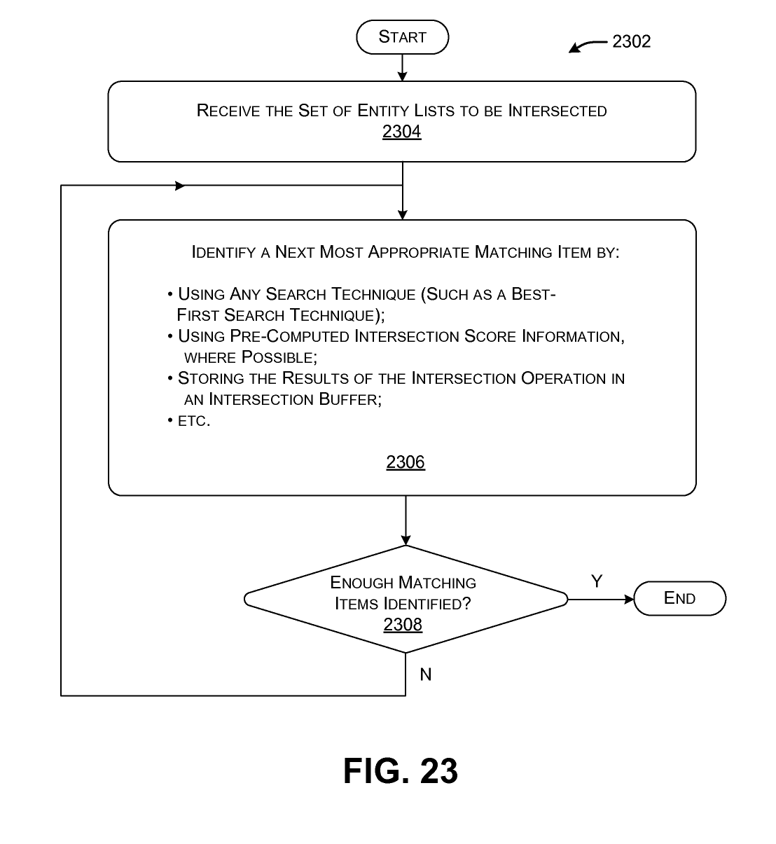

FIG. 23 shows a process 2302 which summarizes the description provided above. In block 2304, the intersection module 118 receives the set of entity lists to be intersected from the query interpretation module 110. In block 2306, the intersection module 118 attempts to identify the most appropriate intersection using the process described above. That process may involve: using any best-first search technique, such as the A* search algorithm; using pre-computed intersection scores, where applicable; storing the results of each intersection operation in an intersection buffer, and so on.

In block 2308, the intersection module 118 determines whether it has identified a sufficient number of matching items having satisfactory scores. If not, then the intersection module 118 can repeat block 2306. If there is a sufficient number of matching items, then the intersection module 118 can terminate the process 2302. The intersection module 118 can use any technique to perform the actual task of intersecting lists, such as a linear merge technique.

As a result of the above-described provisions of the intersection module 118, a user who is interacting with the QPS 102 may perceive the QPS 102 as offering instantaneous or near-instantaneous results, in response to changes made to the input query. For example, assume that a user appends a new term to the input query, or just one or more characters of that new term; the user will perceive the QPS 102 as instantaneously or near-instantaneously updating its results in response to each such a change. Or assume that a user pans over a map to change an in-focus map region, while simultaneously specifying a text-based query; the user will perceive the QPS 102 as instantaneously or near-instantaneously updating its results in response as the user pans across the map.

D. The Post-Processing Module

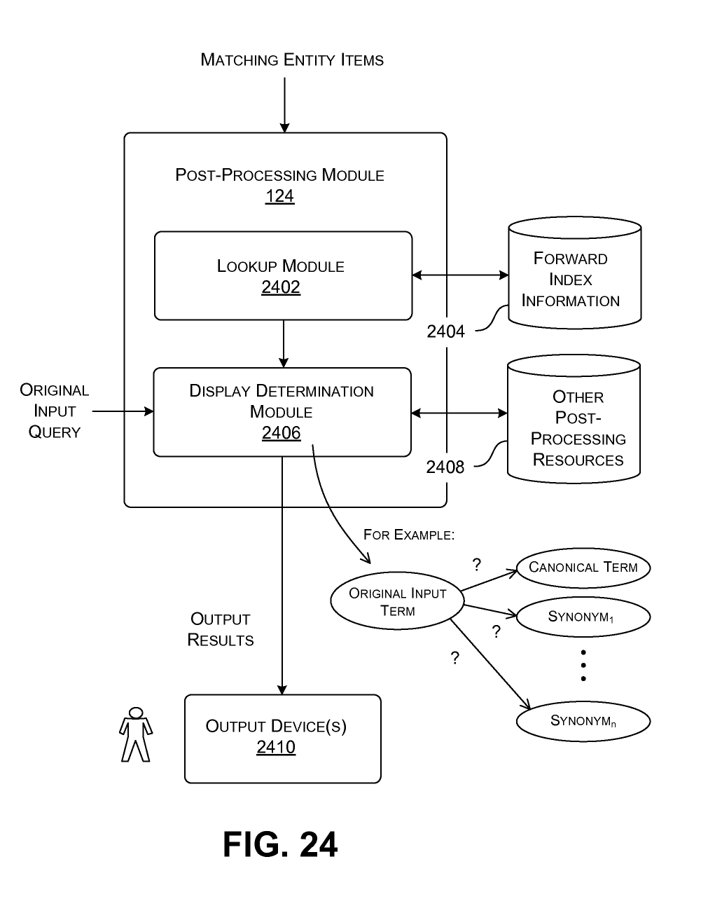

FIG. 24 shows one implementation of the post-processing module 124, introduced in FIG. 1. Recall that the post-processing module 124 produces an output result based on the set of matching items identified by intersection module 118. In one implementation, the output result may correspond, for instance, to any information imparted by the user interface presentation 402 of FIG. 4. That information includes one or more completion suggestions, information regarding the matching items, and so on.

In operation, a lookup module 2402 may retrieve additional information pertaining to each matching item from the forward index information, provided in one or more data stores 2404. For instance, the lookup module 2402 may retrieve information regarding all the attribute values associated with each matching item. In the context of FIG. 2, for instance, assume that one of the matching entities corresponds to one of the entity items associated with a row of the movie table. The lookup module 2402 can retrieve all of the attribute value items in that row.

A display determination module 2406 determines information to be presented to the user, e.g., where that information constitutes the output result. More specifically, in one case, to generate query suggestions, the display determination module 2406 can extract attribute value items from one or more matching items, and use that information in producing the query suggestions. In one case, for example, the query interpretation module 110 may conclude that the user's query “Action movies starring” conforms to a pattern defined by a particular actor-finding rule module. The display determination module 2406 can then extract one or more names of actors from the matching items having the highest scores, for use in generating one or more query suggestions. In another case, the query interpretation module 110 may have already found paths through the grammar which extend beyond the words that the user has provided, as when it concludes that the query “Action movies in” is likely to followed by the word “2013” or “3D,” etc. If this information is available, the display determination module 2406 can mine it in determining the information items to present to the user in one or more query suggestions. In another case, the user's query provides a directed request to retrieve specific information, as when the user inputs the query, “tallest mountain in WA.” Here, the display determination module 2406 can provide query suggestions that incorporate one or more answers to the query.

To complete a prefix, the display determination module 2406 can examine the attribute value items associated with matching items, and identify the attribute value items which appear to be the most likely completions of the specified prefix (e.g., based on the combined scores associated with the matching items and/or any other considerations). In the context of FIG. 3, “pixma” and “powershot” are the most likely completions of the prefix “p”. The display determination module 2406 can then present the proposed prefix completions to the user for his or her consideration.

In forming the suggestions, the display determination module 2406 can use appropriate templates that are stored in the data store 2408. More specifically, to formulate a particular suggestion, the display determination module 2406 can retrieve one or more appropriate templates based on one or more factors, such as the entity item(s) that have been identified by the QPS 102, the parsing results identified by the QPS 102, and so on. The display determination module 2406 can then use relevant identified information items (e.g., attribute value items, entity items, etc.) to fill in the appropriate slot or slots of the identified template(s).

For example, assume that the user has asked a question regarding the age of the actor Tom Cruise. The QPS 102 can identify an entity item associated with the actor Tom Cruise, and, if successful, extract an attribute value item associated with this actor's age. The display determination module 2406 can then retrieve one or more templates that are relevant to the entity item under consideration (“Tom Cruise”) and the attribute item under consideration (“age”). The display determination module 2406 can then plug the name “Tom Cruise” and the identified age value into appropriate slots of the specified template(s). The resultant template(s) may form a natural language expression that conveys the desired age information.

To generate the type of presentations shown in regions 414 and 416 of FIG. 4, the display determination module 2406 can identify the n matching items having the most favorable combined scores, and then present information pertaining to those items, e.g., in the form of information snippets, a histogram, etc.

In connection with the above tasks, note that a particular nexus may exist between each word or phrase in the input query and the decision by the QPS 102 to present a particular matching item for the user's consideration. The display determination module 2406 attempts to identify that nexus, and to present information which explains that nexus to the user; this provision facilitates the user's understanding of the output result in relation to his or her input query. In one such technique, the display determination module 2406 can determine the similarity between a word in the input query and: (a) the canonical words associated with a matching item; and (b) accepted variants of those canonical words, such as synonyms, etc. The display determination module 2406 can identify the closest match and present that information to the user. For example, assume that the input word that is a misspelling of a synonym of an entity's canonical name. The display determination module 2406 can present an indication that the user's term likely matched on the correctly-spelled synonym of the entity's name, e.g., by displaying the correctly-spelled synonym name instead of other ways of referring to the entity. In other cases, a native-language speaker may have entered a query having one or more terms expressed in a foreign language, as when an English-language speaker makes reference to New York as “Nueva York.” The display determination module 2406 can show “New York” along with the matching string, “Nueva York.”

The post-processing module 124 can present the output result on any output device or devices 2210, including a display device, a printer, a speaker, and so on, or any combination thereof.

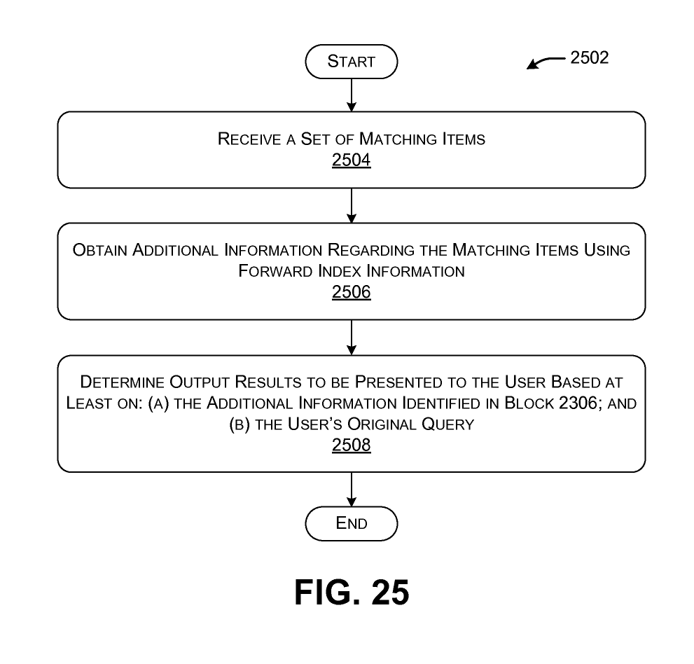

FIG. 25 shows a procedure 2502 which summarizes the above description. In block 2504, the post-processing module 124 receives a set of matching items from the query interpretation module 110. In block 2506, the post-processing module 124 obtains additional information regarding the matching items using forward index information. In block 2508, the post-processing module 124 determines an output result to present to the user based at least on: (a) the additional information identified in block 2106; and, optionally (b) the terms in the user's original query, etc.

E. Representative Computing Functionality

FIG. 26 shows computing functionality 2602 that can be used to implement any aspect of QPS 102 of FIG. 1. For instance, the type of computing functionality 2602 shown in FIG. 26 can be used to implement any aspect of the local computing functionality (502, 602) of FIGS. 5 and 6, and/or the remote computing functionality 604 of FIG. 6. In all cases, the computing functionality 2602 represents one or more physical and tangible processing mechanisms.

The computing functionality 2602 can include one or more processing devices 2604, such as one or more central processing units (CPUs), and/or one or more graphical processing units (GPUs), and so on.

The computing functionality 2602 can also include any storage resources 2606 for storing any kind of information, such as code, settings, data, etc. Without limitation, for instance, the storage resources 2606 may include any of: RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removal component of the computing functionality 2602. The computing functionality 2602 may perform any of the functions described above when the processing devices 2604 carry out instructions stored in any storage resource or combination of storage resources.

As to terminology, any of the storage resources 2606, or any combination of the storage resources 2606, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 2602 also includes one or more drive mechanisms 2608 for interacting with any storage resource, such as a hard disk drive mechanism, an optical disk drive mechanism, and so on.

The computing functionality 2602 also includes an input/output module 2610 for receiving various inputs (via input devices 2612), and for providing various outputs (via output devices 2614). The input devices 2612 can include any of key entry devices, mouse entry devices, touch-enabled entry devices, voice entry devices, and so on. One particular output mechanism may include a presentation device 2616 and an associated graphical user interface (GUI) 2618. The computing functionality 2602 can also include one or more network interfaces 2620 for exchanging data with other devices via one or more networks 2622. One or more communication buses 2624 communicatively couple the above-described components together.

The network(s) 2622 can be implemented in any manner, e.g., by a local area network, a wide area network (e.g., the Internet), point-to-point connections, etc., or any combination thereof. The network(s) 2622 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 2602 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the functionality described above can employ various mechanisms to ensure the privacy of user data maintained by the functionality, if any, in accordance with user expectations and applicable laws of relevant jurisdictions. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

Further, the description may have described various concepts in the context of illustrative challenges or problems. This manner of explanation does not constitute a representation that others have appreciated and/or articulated the challenges or problems in the manner specified herein. Further, the claimed subject matter is not limited to implementations that solve any or all of the noted challenges/problems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by one or more computing devices, for processing a query, comprising:
receiving an input query, corresponding to a complete query or a yet-to-be-completed query;
interpreting the input query with respect to information provided in a structured knowledge base, using a set of rule modules associated with a grammar, to identify a set of one or more constraints expressed by the input query; and
providing an output result based on the set of constraints,
at least one rule module in the grammar being a numeric-constraint rule module that is used to process a numeric constraint expressed in the input query,
the numeric constraint being expressed using at least one number and/or at least one word of a natural language.

2. The method of claim 1, wherein the numeric-constraint rule module includes logic for:
determining when the numeric-constraint rule module has been invoked; and
when invoked, extracting one or more information items from the structured knowledge base, relative to at least one specified value.

3. The method of claim 2, wherein said one or more information items correspond to one or more entity items.

4. The method of claim 2, wherein said one or more information items correspond to one or more attribute value items associated with one or more entity items.

5. The method of claim 2, wherein said at least one specified value corresponds to a single-bound value, and wherein said one or more information items are associated with respective values that are no larger than the single-bound value, or no smaller than the single-bound value.

6. The method of claim 2, wherein said at least one specified value corresponds to a range of values, and wherein said one or more information items are associated with respective values that lie within the range of values.

7. The method of claim 2, further comprising applying a weighting function to said one or more information items.

8. The method of claim 7,
wherein said one or more information items are associated with one or more respective position values, and
wherein the weighting function provides a weight for each information item that is based on a distance between a position value, associated with the information item, and a reference position value.

9. The method of claim 2, wherein said at least one specified value is specified in an indirect manner, resolution of which depends on a result provided by execution of at least one other rule module.

10. The method of claim 9, wherein said numeric-constraint rule module and said at least one other rule module make inquiries into at least two tables of the structured knowledge base associated with at least two respective subjects.

11. The method of claim 1, wherein the numeric-constraint rule module is configured to:
identify the numeric constraint in the input query; and
decompose the numeric constraint into two or more sub-constraints, wherein said interpreting involves interpreting the input query based on said two or more sub-constraints.

12. The method of claim 11,
wherein the numeric constraint is associated with a master range, and
wherein each sub-constraint corresponds to a sub-range encompassed by the master range.

13. The method of claim 1, wherein at least one other rule module corresponds to a comparison rule module that is used to process a comparison-based constraint expressed in the input query, in which at least a first item is compared to a second item.

14. The method of claim 1,
wherein said interpreting of the input query also includes identifying at least one variant of a word expressed in the input query, and
wherein said interpreting involves interpreting the input query to include consideration of said at least one variant.

15. The method of claim 1, wherein said interpreting of the input query also includes:
identifying an originally-specified prefix in the input query; and
identifying two or more extended prefixes for the originally-specified prefix in the input query,
wherein said interpreting involves interpreting the input query based on the extended prefixes.

16. The method of claim 1,
wherein said interpreting also involves generating a set of entity lists associated with the set of constraints,
wherein each entity item in an entity list corresponds to an entity described in the structured knowledge base which satisfies at least one of the constraints, and
wherein the method further comprises performing an intersection operation based on the set of entity lists, to generate a set of matching items, each of which satisfies all of the constraints in the set of constraints.

17. The method of claim 16, wherein said performing of the intersection operation further comprises utilizing at least one instance of pre-computed information, associated with a pre-computed intersection between two or more entity lists.

18. A query processing system, implemented by one or more computing devices, for processing an input query, comprising:
a data store that stores a structured knowledge base, the structured knowledge base specifying attribute value items, associated with a set of entity items, in a structured manner;
a data store that stores a set of rule modules that correspond to a grammar;
a query interpretation module configured to:
receive an input query, corresponding to a complete query or a yet-to-be-completed query; and
interpret the input query with respect to information provided in the structured knowledge base, using the set of rule modules, to identify: (a) a set of one or more constraints expressed by the input query; and (b) a set of entity lists associated with the set of constraints,
each entity item in an entity list corresponding to an entity described in the structured knowledge base which satisfies at least one of the constraints;
an intersection module configured to perform an intersection operation based on the set of entity lists, to generate a set of matching items that satisfy all of the constraints in the set of constraints; and
a post-processing module configured to provide an output result based on the set of matching items,
at least one rule module in the grammar corresponding to a parent rule module, containing a reference to at least one child rule module,
the parent rule module providing an output result which is dependent on another output result generated by said at least one child rule module.

19. The query processing system of claim 18, wherein the parent rule module generates at least one entity list based on a numeric constraint expressed in the input query.

20. A computer readable storage medium for storing computer readable instructions, the computer readable instructions performing a method, when executed by one or more processing devices, that comprises:
receiving an input query, corresponding to a complete query or a yet-to-be-completed query;
interpreting the input query with respect to information provided in a structured knowledge base, using a set of rule modules associated with a grammar, to identify a set of one or more constraints expressed by the input query; and
providing an output result that reflects the set of constraints,
at least one rule module in the grammar, corresponding to a parent rule module, containing a reference to at least one child rule module,
the parent rule module providing an output result which is dependent on another output result generated by said at least one child rule module.
